(19) United States
(12) Patent Application Publication
(10) Pub. No.: US 2017/0325113 A1
(43) Pub. Date: Nov. 9, 2017

(54) ANTMONITOR: A SYSTEM FOR MOBILE NETWORK MONITORING AND ITS APPLICATIONS

(71) Applicant: THE REGENTS OF THE UNIVERSITY OF CALIFORNIA, OAKLAND, CA (US)

(72) Inventors: ATHINA MARKOPOULOU, IRVINE, CA (US); ANASTASIA SHUBA, IRVINE, CA (US); EMMANOUIL ALIMPERTIS, IRVINE, CA (US); JANUS VARMARKEN, IRVINE, CA (US); MINAS GJOKA, IRVINE, CA (US); MINH THOAI ANH LE, IRVINE, CA (US); SIMON LANGHOFF, IRVINE, CA (US)

(21) Appl. No.: 15/587,291

(22) Filed: May 4, 2017

Related U.S. Application Data
(60) Provisional application No. 62/331,523, filed on May 4, 2016.

(51) Int. Cl. H04W 24/08; H04W 4/20; H04M 1/725; H04L 29/06; H04L 12/26; H04W 12/02; H04L 12/46

(52) U.S. Cl. CPC H04W 24/08; H04W 12/02; H04W 4/20; H04M 1/72525; H04L 12/4641; H04L 43/08; H04L 43/065; H04L 43/045; H04L 67/42

(57) ABSTRACT

AntMonitor is a system for passive monitoring, collection, and analysis of fine-grained, large-scale packet measurements from mobile devices. The system may be implemented on top of a VPN-based service and using two possible architectures: Client-Server or Mobile-Only. A current implementation of the Mobile-Only design may outperform other mobile-only approaches: it may achieve, for example, 2× and 8× faster (down and uplink) speeds, and close to the raw no-VPN throughput, while using 2-12× less energy. AntMonitor can scale to a large number of end-users, provide enhanced privacy protection, and enable accurate traffic classification. The system may support (i) real-time detection and prevention of private information leak-age from the device to the network; (ii) passive performance measurements network-wide as well as per-user; and (iii) traffic classification at different granularities (including per-application or per device, and user profiling) based on TCP/IP header features.

### STATEMENT OF GOVERNMENT SUPPORT

This invention was made with Government support under Grant Nos. 1028394, 1228995, awarded by the National Science Foundation. The Government has certain rights in the invention. This application claims priority to Provisional application 62/331,523 filed May 4, 2016.

### BACKGROUND OF THE INVENTION

The present invention relates to monitoring communication traffic. More particularly, the present invention relates to monitoring network traffic from communication devices such as mobile devices.

Mobile devices may have become ubiquitous. The number of unique mobile users and the number of cellular subscribers may have reached half of the world population. People may spend more time on their mobile devices than on traditional desktop computers, and the majority of all IP traffic may be generated by mobile devices, which may increase to two-thirds by 2019. Therefore, looking at network activity from the mobile device's point of view may be of interest to network operators and individual users alike.

Other Monitoring Approaches.

Work on monitoring network traffic generated by mobile devices can be roughly classified according to the vantage point and measurement approach.

OS Approaches.

Using a custom OS or a rooted phone one can get access to fine-grained information on the device, including passive monitoring of packet-level network traffic, typically using packet capture APIs such as tcpdump or iptables-log. Examples include Phonelab and others. This is a powerful approach but inherently limited to small scale-deployment as the overwhelming majority of users do not have rooted phones, and wireless providers and phone manufacturers strongly discourage rooting.

Active Measurements from Mobile Devices.

There are mobile apps, developed by researchers Netalyzr, Mobilyzer or the industry (e.g., Speedtest, CarrierlQ or Tutella), to perform active network measurements of various metrics (throughput, latency, RSS) from the mobile device. They run at user space, without rooting the phone, and allow for accurate measurements. However, care must be put to not burden the device's resources and crowdsourcing is often used to distribute the load.

Passive Monitoring Inside the Network.

ISPs and other organizations sometimes passively capture mobile network traffic on links in the middle of their networks, e.g. at an ISP's or other organization's network. Researchers typically analyze network traces collected by others (e.g. large tier-1 networks or from university campus WiFi networks). Limitations of this approach include that (i) it only captures traffic going through the particular measurement point and (ii) it has access only to packet headers (payload is increasingly encrypted), not to ground truth or semantic-rich info. (e.g., apps that produced the packets).

In Client-Server VPN approaches, packets are tunneled from the VPN client on the mobile device to a remote VPN server, where they can be processed or logged. A representative of this approach is Meddle, which builds on top of the StrongSwan VPN software. Additional tools have been built on top of Meddle: to detect content manipulation by ISPs and traffic differentiation, and to detect privacy leaks. Disadvantages of this approach include the fact that packets are routed through a middle server thus posing additional delay and privacy concerns, lack of client-side annotation (thus no ground truth available at the server), and potentially complex control mechanisms (the client has to communicate the selections of functionalities, e.g., ad blocking, to the server). An advantage of the client-server VPN-based approach is that it can be combined with other VPN and proxy services (e.g., encryption, private browsing) and can be attractive for ISPs to offer as an added-value service.

In Mobile-Only VPN approaches, the client establishes a VPN service on the phone to intercept all IP packets and does not require a VPN server for routing. It extracts the content of captured outgoing packets and sends them through newly created protected UDP/TCP sockets to reach Internet hosts; and vice versa for incoming packets. This approach may have high overhead due to this layer-3 to layer-4 translation, the need to maintain state per connection and additional processing per packet. If not carefully implemented, this approach can significantly affect network throughput: for example, see the poor performance of tPacketCapture—an application currently available on Google Play that utilizes this mobile-only approach. Therefore, careful implementation is crucial to achieve good performance.

Two state-of-the-art representatives of the mobile-only approach are Haystack and Privacy Guard. They both focus on applying and optimizing their systems for detection of PII leaks. Haystack is currently in beta testing mode, with a paper under submission, and it may be the closest baseline for comparison to AntMonitor-Mobile-Only. It analyzes app traffic on the device, even if encrypted in user-space, and it does not require root permissions or a server in the middle. In terms of implementation, our evaluation shows that AntMonitor Mobile-Only can achieve 2× and 8× the downlink and uplink throughput. ICSI's previous Netalyzrtool has also been adapted for mobile and used to detect private information leakage via HTTP Header Enrichment. Privacy Guard is another recent product that adopts the mobile-only design, albeit with some different implementation choices, which lead to inferior performance when compared to both AntMonitor and Haystack.

As can be seen, there is a need for a system for mobile networking and its applications.

### BRIEF DESCRIPTION OF THE DRAWINGS

FIG. 1a is screenshot of a Home Screen according an exemplary embodiment of the invention;

FIG. 1b is screenshot of a Select Applications to Log screen according an exemplary embodiment of the invention;

FIG. 1c is a screenshot of a Leaks to Detect screen according to an exemplary embodiment of the invention;

FIG. 1d is a screenshot of a Privacy Leak Alert screen according to an exemplary embodiment of the invention;

FIG. 1e is a screenshot of a History of Leaks screen according to an exemplary embodiment of the invention;

FIG. 1f is a screenshot of a Visualization screen according to an exemplary embodiment of the invention. This particular visualization shows which apps send traffic to what destination IP. Apps are depicted by the corresponding icons and destination IPs as black nodes (the IP address is shown if the user clicks on the node); the edge between an app and a destination IP depicts the fact that the app sent a packet to that destination. The graph is updated in real-time as packets are sent.

FIG. 2a illustrates a block diagram of an exemplary client-server embodiment of the invention;

FIG. 2b illustrates a block diagram of an exemplary mobile-only embodiment of the invention;

FIG. 3 is a flowchart showing performance optimization for an exemplary embodiment of the invention;

FIG. 4a is a chart showing download performance according to an exemplary embodiment of the invention;

FIG. 4b is a chart showing upload performance according to an exemplary embodiment of the invention;

FIG. 4c is a chart showing variations of AM Mobile-Only upload performance according to an exemplary embodiment of the invention;

FIG. 5 is a chart showing performance of Virtual Private Network applications during device idle time according to an exemplary embodiment of the invention;

FIG. 6 is a chart showing Data logged daily by different users according to an exemplary embodiment of the invention;

FIG. 7 is a chart showing an amount of traffic sent towards ad servers and analytics services according to an exemplary embodiment of the invention;

FIG. 8a is a performance map showing a large area with only a few users according to an exemplary embodiment of the invention;

FIG. 8b is a performance map showing areas with moderate to poor LTE (Long Term Evolution) signals according to an exemplary embodiment of the invention;

FIG. 9a is a chart showing data used by a user in a typical day according to an exemplary embodiment of the invention;

FIG. 9b is a chart showing data used by a user in a typical weekend day according to an exemplary embodiment of the invention;

FIG. 10a is a chart showing a score for increasing numbers of features according to an exemplary embodiment of the invention;

FIG. 10b is a chart showing a normalized confusion matrix for all features according to an exemplary embodiment of the invention; and

FIG. 11 is a chart showing supervised classification of users based on mobile applications used according to an exemplary embodiment of the invention;

FIG. 12 shows a comparison between Client-Server and Mobile-Only Virtual Private Network approaches;

FIG. 13 is a chart showing flows leaking PII found in collected data; and

FIG. 14 is a chart showing active v. passive throughput measurements in an exemplary embodiment of the invention.

### SUMMARY OF THE INVENTION

In one aspect of the invention, a method of mobile network monitoring includes: a graphical user interface that allows a user to turn a virtual private network on or off, select which applications to monitor, select which analysis and logging to perform and what results to upload and visualize; a method for intercepting all packets in and out of the device that may use a virtual private network (VPN) service on the device; a routing module that interacts with said intercepting method and routes packets to/from their target/source host; a log module for logging entire datagrams or metadata on the device, and for uploading all or parts of the log files from the device to a log server; and an analysis and visualization module on the device and/or at the log server.

In another aspect of the invention, a computer program product for mobile network monitoring includes a computer program product comprising a computer readable storage medium having program instructions embodied therewith, the program instructions using a computer processor to cause the mobile device and/or a cloud server to: allow a user to turn a virtual private network on or off using a graphical user interface and select applications for contributing data to data collection; manage a network tunnel (TUN) interface and route the data for the data collection by extracting a datagram from the data, routing the datagram to a target host, wrapping a response from the target host in a datagram, and writing the response to the network tunnel interface; log files with some of the data for the data collection and upload them to a log server; and analyze packets from the data for the data collection and visualize them.

In another aspect of the invention, a system for network monitoring includes: a computer processor with a central processing unit; a memory; a battery; a power sensor; wherein the central processing unit is configured to: compute speed of network throughput from a number of bytes transferred; calculate a standard deviation of the sampled speed; calculate usage of the memory by sampling a resident set size (RSS) value; calculate usage of the battery by utilizing the power sensor to compute an energy usage; calculate CPU usage by sampling CPU usage percentage by a plurality of applications.

These and other features, aspects and advantages of the present invention will become better understood with reference to the following drawings, description and claims.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a system for mobile network monitoring. AntMonitor is a system for collection and analysis of fine-grained, large-scale network measurements from mobile devices. AntMonitor may be a high-performance passive monitoring tool for crowdsourcing a range of mobile network measurements, as it combines the following desired properties: (i) it may be easy to install (it does not require administrative privileges) and use (it runs as a service app in the background); (ii) it may scale well; (iii) it may provide users with fine-grained control of which data to monitor or log; (iv) it may support real-time analysis on the device (thus enhancing privacy) and/or on a server; and (iv) it may allow for semantic-rich annotation of packet traces.

AntMonitor may be implemented on top of a VPN-based service, which is a way today to intercept all packets without rooting the phones. We developed and compare two versions of the architecture: Client-Server and Mobile-Only. They both use a VPN client on the device to intercept packets. While Client-Server routes them through a remote VPN server, Mobile-Only translates all connections on the device itself. In both versions, there is a separate logging server for uploading logs from the device for subsequent analyses. Our implementation of AntMonitor Mobile-Only outperforms existing mobile-only approaches in terms of throughput and energy, without significantly impacting CPU and memory usage. Specifically, our implementation of AntMonitor-Mobile-Only achieves 2× and 8× (the downlink and uplink) throughput of state-of-the-art mobile-only approaches, namely Privacy Guard and Haystack, while using 2-12× less energy. The achieved throughput is also at 94% of the throughput without VPN.

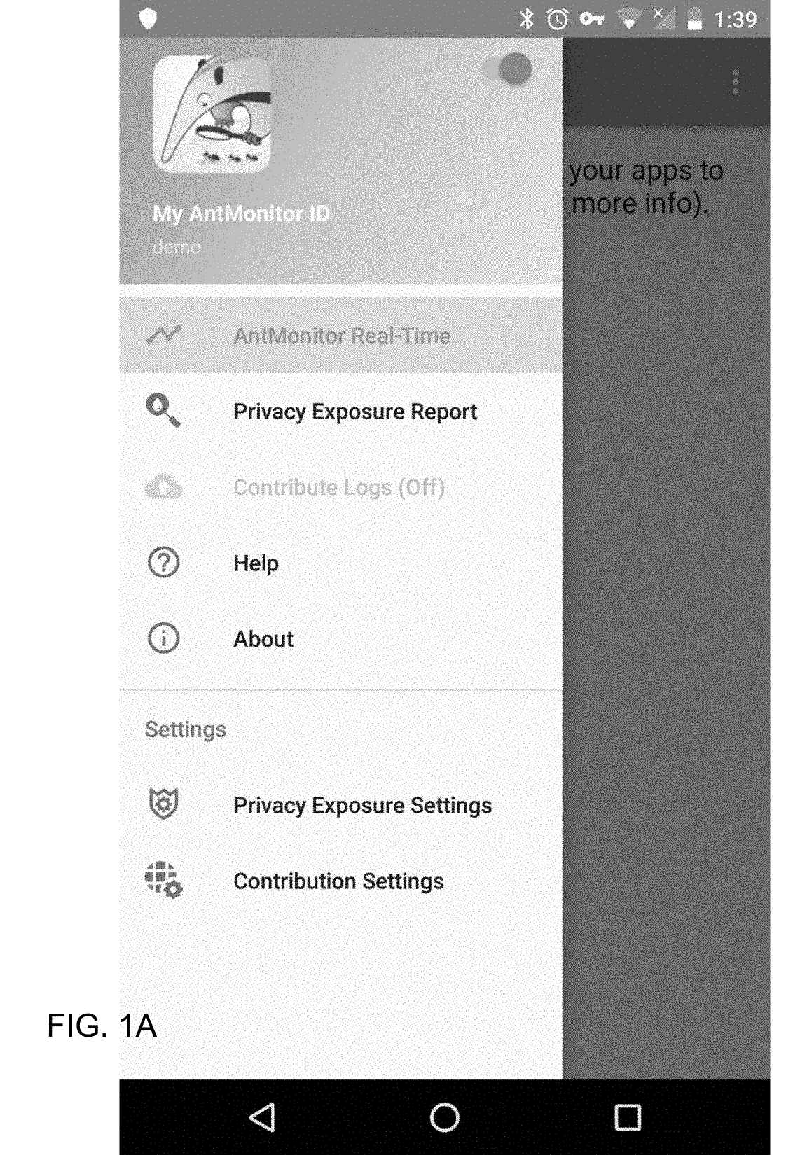

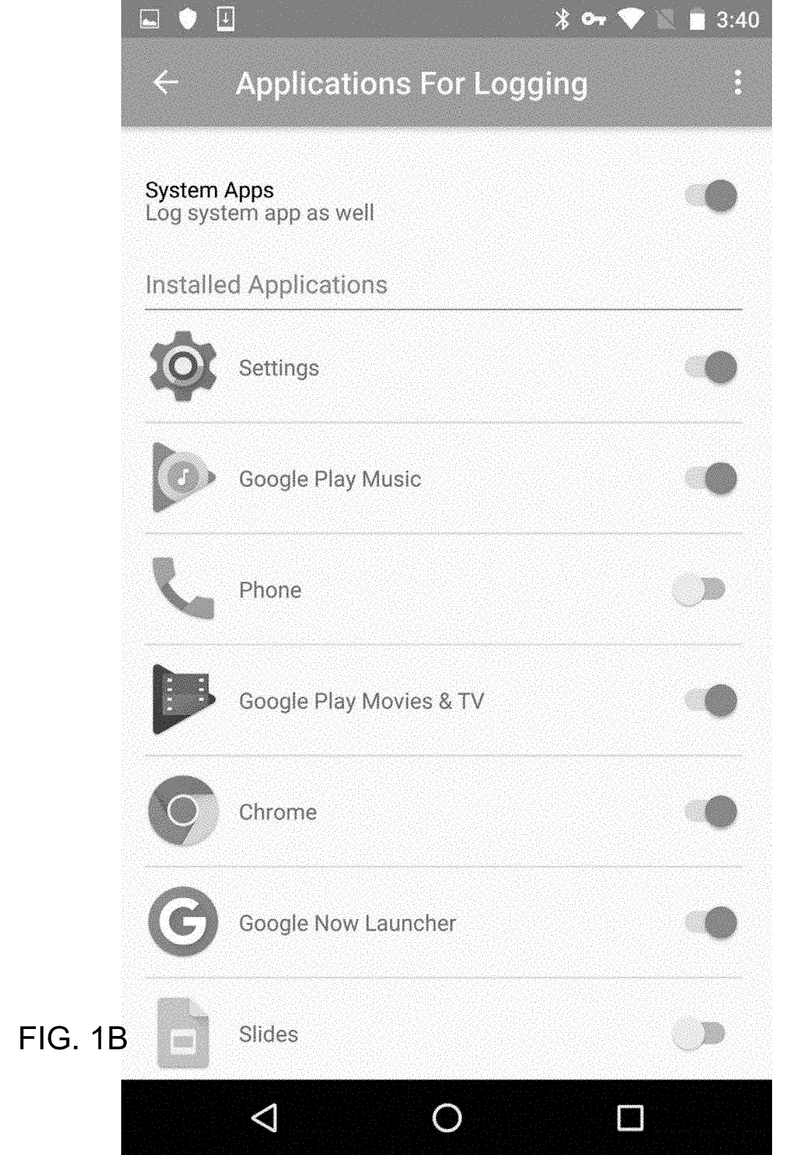

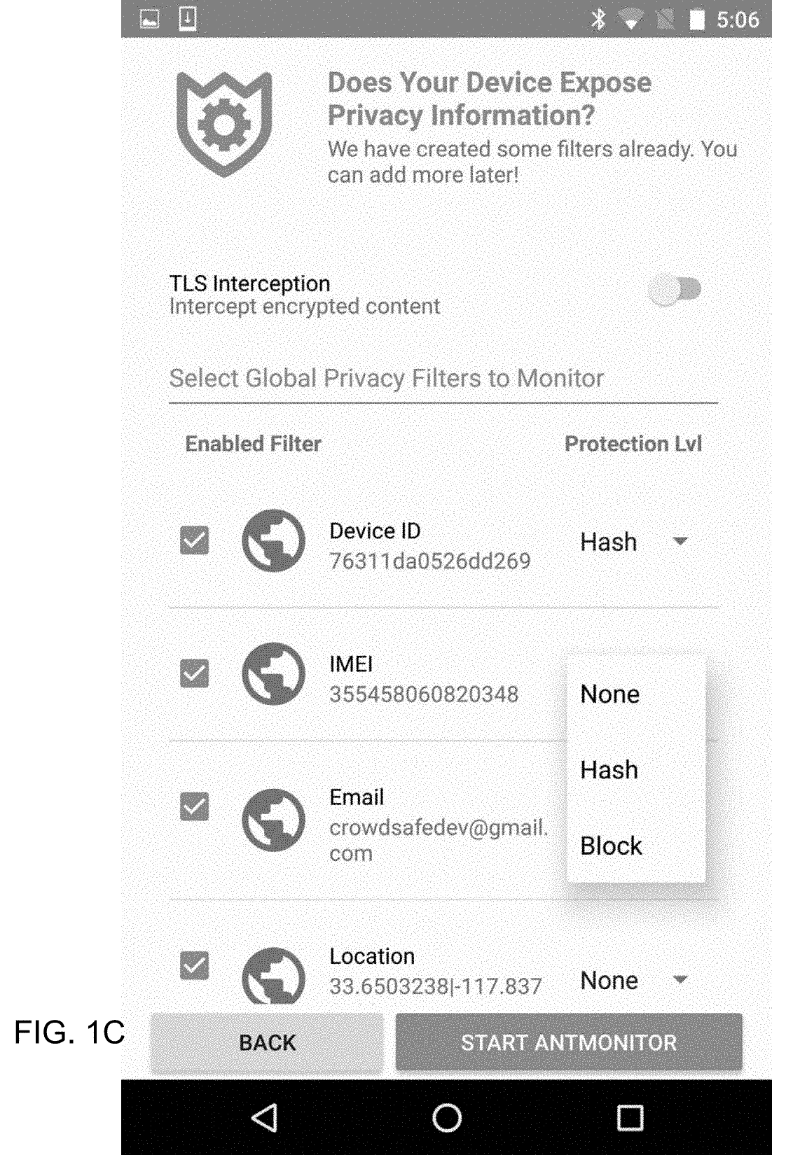

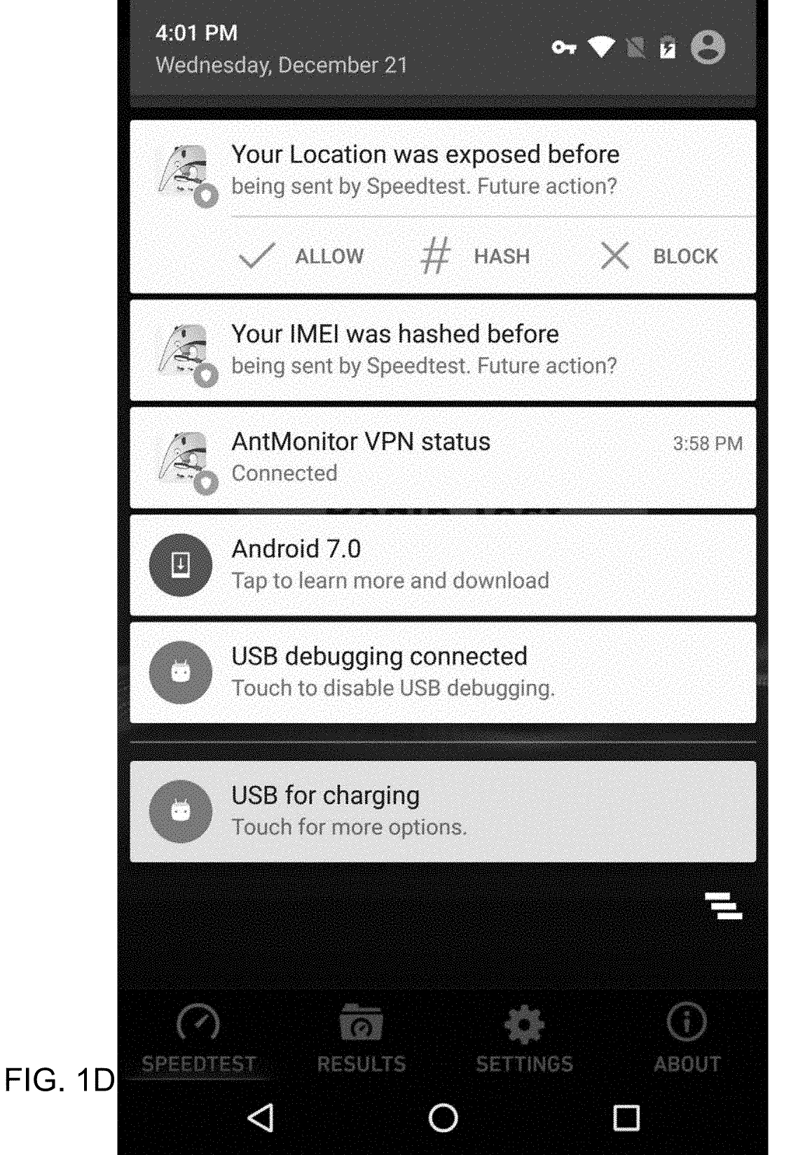

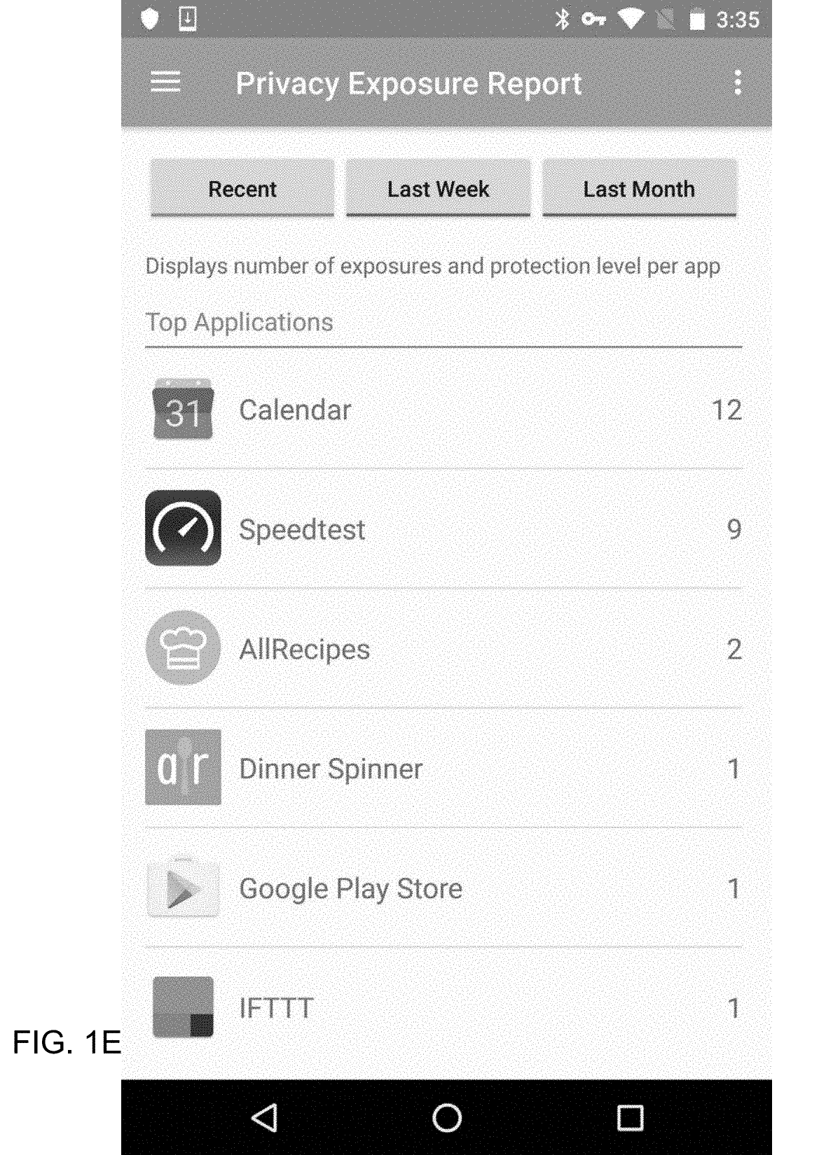

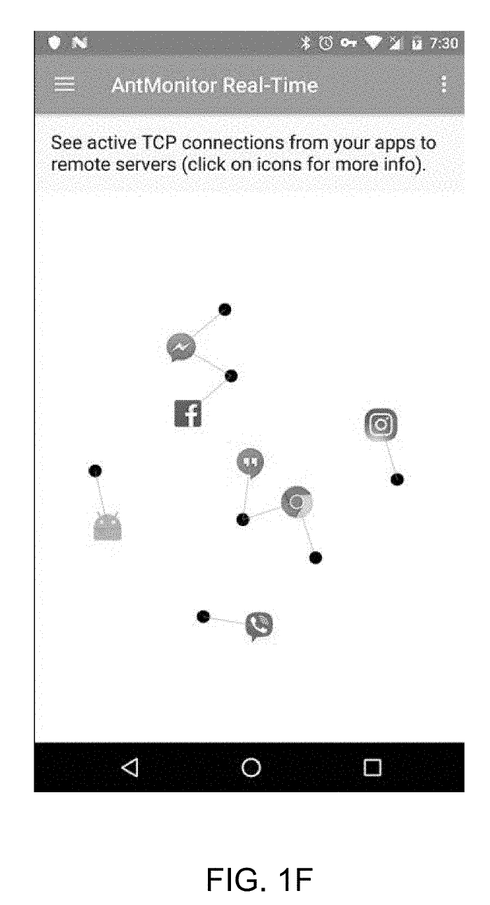

AntMonitor may naturally lend itself as a platform for a range of applications that build on top of passive monitoring, which can be of interest to individual users, network operators, and researchers. First, AntMonitor may detect when leakage of private information from the device to the network occurs. AntMonitor may be an app that can provide real-time detection and prevention today, together with insight into the destinations the private information leaks to. Second, AntMonitor may be used for passive performance measurements network-wide (e.g., network performance maps) as well as per-user (usage profiles). With AntMonitor, this information may come at no additional bandwidth overhead and can provide input into network provisioning. Third, packet traces collected by AntMonitor, annotated with rich contextual information, may be used to train machine learning models for traffic classification of flows to applications using only TCP/IP header features. The present invention can achieve higher classification accuracy than state-of-art classification methods that use HTTP payload. Results from a pilot user study at UCI demonstrate the capabilities of AntMonitor and its enabling potential for these applications. FIG. 1 shows some screenshots of an exemplary embodiment of the invention as an android application).

### The Antmonitor System

The main design objectives of AntMonitor and the key design choices to achieve those objectives are described.

Objective 1: Large-Scale Measurements: AntMonitor may be used to crowdsource data from a large number of users, which poses a number of system requirements. First, the app on the mobile device may run without administrative privileges (root access). To that end, we use the public Virtual Private Network (VPN) API. Second, in order for a large number of mobile users to adopt it, user experience may not be affected: the monitoring tool can run seamlessly in the background while the user continues to use the mobile device as usual, and the overhead on the device may be negligible in terms of network throughput, CPU, battery, and data cost. The performance of any server used for data collection and analysis may scale with the number of users.

Objective 2: Making it Attractive for Users: In addition to the technical aspects of scalability, there may be incentives for users to participate. To that end, AntMonitor may be designed with the capability to offer users a variety of services. The current prototype may offer enhanced privacy protection (e.g., preventing leakage of private information) and visualizations that help users understand where their data flows (e.g. see FIG. 1(f)). Other services could be implemented completely on the client side, such as enhanced wireless network performance (e.g., increase data rates by switching among available networks). Finally, Ant-Client may provide users with control over which data they choose to contribute to the AntMonitor logging system, i.e., which applications to monitor, and whether to contribute full packets or headers only.

Objective 3: Fine-Grained Information: AntMonitor may support full-packet capture of both incoming and outgoing traffic. It may collect packet traces in PCAP Next Generation format, which may append arbitrary information alongside the raw packets. This additional capability may be very important because in many cases, the contextual information may only be collected accurately at the client side at the time of packet capture, and may play a critical role in subsequent analyses. In particular, contextual information that AntMonitor can collect include names of apps that generate those packets (thus providing the ground truth for application classification), location, background apps, and information about the network used (network speed, signal strength, etc.).

System Design

To support the above main objectives, AntMonitor may provide the following main functionalities: traffic interception, routing, logging, and analysis.

Traffic Interception. The mobile app, called AntClient, can establish a VPN service on the device that runs seamlessly in the background. The service can intercept all outgoing and incoming IP datagrams by creating a virtual (layer-3) TUN interface and updating the routing table so that all outgoing traffic, generated by any app on the device, is sent to the TUN interface. AntClient then can route the datagrams to their target hosts on the Internet (as described below). When a host responds, the response can be routed back to AntClient, and AntClient then can send the response packets to the apps by writing them to TUN.

Traffic Routing. To route IP datagrams generated by the mobile apps and arriving at the TUN interface, the intuitive option may be to use raw sockets. However, this option may not be available on non-rooted devices. Therefore, the datagrams have to be sent out using layer-4 (UDP/TCP) sockets, which can be done in two ways:

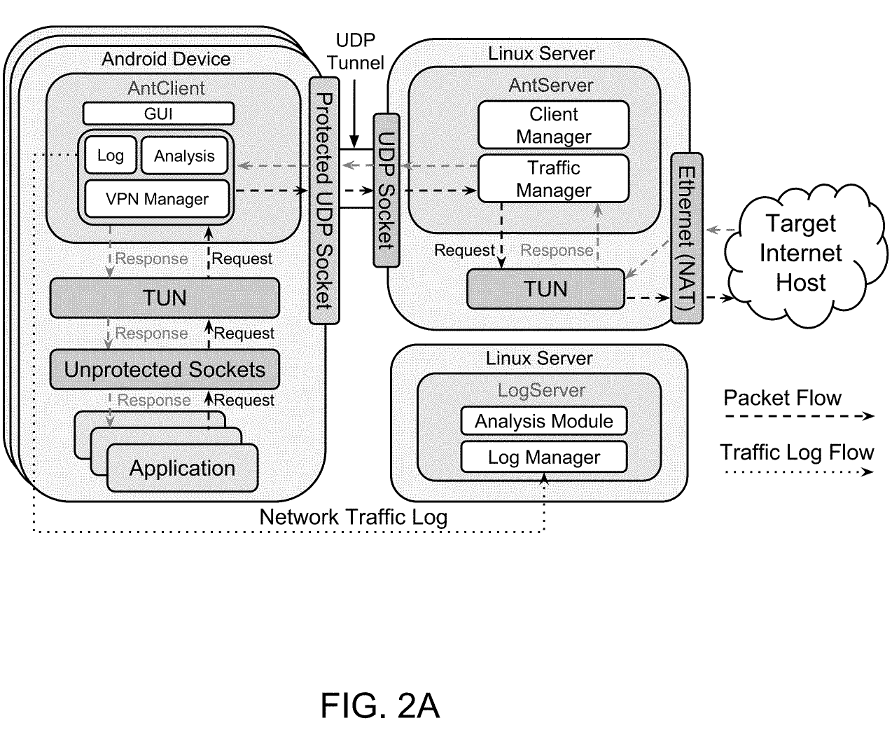

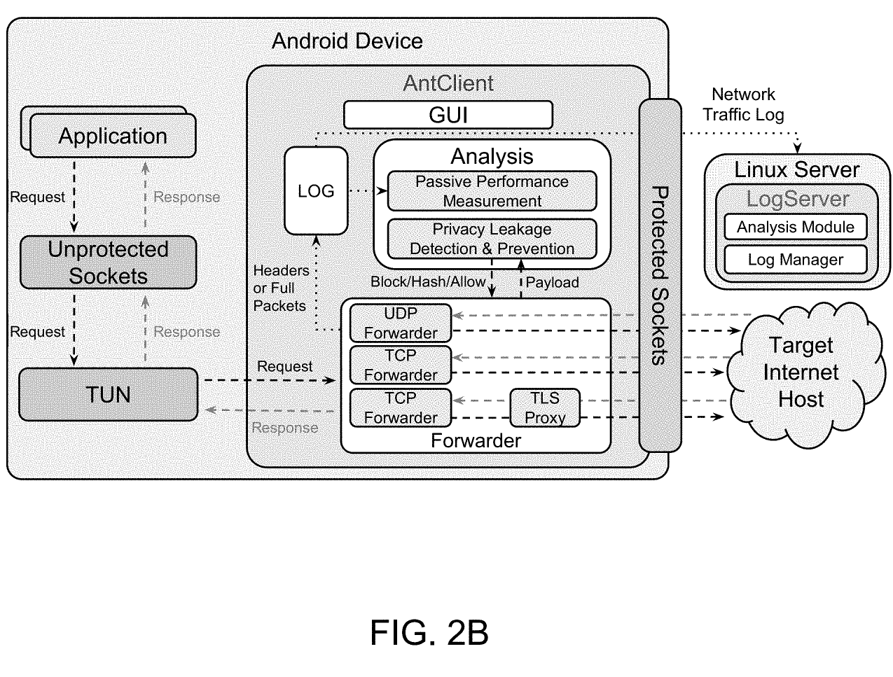

1. Client-Server Routing: A server (AntServer), may be used to assist with the routing of IP datagrams, as depicted on FIG. 2(a). This design is similar to the design of VPN services. In particular, AntClient can send the datagrams out through a UDP socket to AntServer on the cloud, which can route the datagrams towards their destinations. To avoid having the outgoing data of this socket looped back to the TUN interface, AntClient can use a protected UDP socket.

An advantage of this client-server design may be the simplicity of implementation: the routing can be done seamlessly by the operating system at the server with IP forwarding enabled. However, as a crowdsourcing system, the requirement of AntServer may face challenges on scaling the system up to support a large number of users. Furthermore, users may not want their traffic to change path. Therefore, an alternative routing approach may be used that can be performed entirely on the mobile device, without the need of AntServer, as described next.

2. Mobile-Only Routing: Routing IP datagrams to target hosts directly through layer-4 sockets requires a translation between layer-3 datagrams and layer-4 packets. In other words, for outgoing traffic, data of the IP datagrams may need to be extracted and sent directly to the target hosts through UDP/TCP sockets. When a target host responds, its response data may be read from the UDP/TCP sockets and wrapped in IP datagrams, which may be then written to the TUN interface. To this end, a new component, called Forwarder, takes care of this translation. How the Forwarder fits into the design of AntMonitor is shown in FIG. 2(b).

This Mobile-Only design removes the dependency on AntServer for routing traffic; thus, it allows AntClient to be self-contained and makes AntMonitor easy to scale. Furthermore, this design enhances users' privacy as all data can now stay on the mobile device and is not routed through a middlebox.

Interception of Encrypted Traffic

In order to inspect encrypted traffic, we may implement a TLS proxy. Since plain text is used in order to perform Deep Packet Inspection (DPI), and much of the traffic is encrypted, AntClient also includes a TLS proxy to intercept secure connections, decrypt the packets, and then re-encrypt them before sending them to their intended Internet hosts. An example implementation is using the open-source SandroProxy library. This method works for most apps, but it cannot intercept traffic from highly sensitive apps, such as banking apps, that use certificate pinning. Due to the intrusive nature of TLS/SSL interception, AntMonitor allows users to disable this option. In an exemplary implementation of AntMonitor, TLS interception is implemented in the Mobile-Only Architecture, as depicted in FIG. 2(b).

System Implementation

The Client-Server and Mobile-Only approaches, depicted in FIGS. 2(a) and (b), respectively, share interception, logging, and analysis components, but they differ in the routing component.

AntClient

In addition to traffic interception and routing, the AntClient contains a Graphical User Interface (GUI) and modules for logging (Log), real-time and/or offline Analysis of packets, and TLS interception. One embodiment of AntClient is as an Android application.

GUI

FIG. 1 shows screenshots of the GUI from the AntMonitor android app. The user can turn the VPN service on or off, select various options and run various applications (discussed in Sec. 5). FIG. 1(b) shows that the user can select which applications may be monitored and logged and also whether to contribute full packets or headers only. FIG. 1(c) shows how the user can select which strings to monitor for privacy leaks, FIG. 1(d) shows the privacy leak alerts and history, respectively. FIG. 2(f) is a screen-shot from a real-time visualization of where the traffic is going: it depicts which application sends traffic to which IP destination. Several other visualizations are possible. For example a similar graph could be constructed for contacted URLs, thus visualizing the user browsing behavior.

AntClient:

The Graphical User Interface may allow the user to turn the VPN service on and off, and to select which applications are permitted to contribute to the data collection. Furthermore, advanced users can choose to contribute full packets or headers only. FIG. 1 shows screenshots of AntClient's GUI. (For example, FIG. 1a shows a screenshot of a Homescreen). The Forwarder can manage the TUN interface and is in charge of routing network traffic.

The Forwarder may include two main components: UDP and TCP Forwarder (FIG. 2(b)). The UDP Forwarder is the simpler component as UDP connections are stateless. When an app sends out an IP datagram containing a UDP packet, the UDP Forwarder records the mapping of the source and destination tuples, where a tuple includes an IP address and a port number.

This mapping is used for the reverse lookup later on. The Forwarder then can extract the data of the UDP packet and send the data to the remote host through a protected UDP socket. When a response is read from the UDP socket, the Forwarder can create a new IP datagram, and change the destination tuple to one that corresponds to the source tuple in the recorded mapping. The datagram is then written to TUN.

The TCP Forwarder works like a proxy server. For each TCP connection made by an app on the device, a TCP Forwarder instance can be created. This instance maintains the TCP connection with the app by responding to IP datagrams read from the TUN interface with appropriately constructed IP datagrams. This entails following the states of the TCP connection (LISTEN, SYN_RECEIVED, ESTABLISHED, etc.) on both sides (app and TCP Forwarder) and careful construction of TCP packets with appropriate flags (SYN, ACK, RST, etc.), options, and sequence and acknowledgment numbers.

At the same time, the TCP Forwarder can create an external TCP connection to the intended remote host through a protected socket to forward the data that the app sent to the server and the response data from the server to the app.

The Log Module can write packets (or just packet headers) to log files and upload them to LogServer. This module can add rich contextual information to the captured packets by using the PCAP Next Generation format. For instance, the invention can store application names and network statistics alongside the raw packets. The mapping to app names can be done by looking up the packets' source and destination IPs and port numbers in the list of active connections available in /proc/net, which can provide the UIDs of apps responsible for each connection. Given a UID, we can get the corresponding package name using APIs. The Log Module can also support different type of measurements (beyond packet traces, other readings from the device or the network) and log file format (e.g. JSON), depending on the application. Finally, Log Module periodically uploads the log files to LogServer during idle time, i.e., when the device is charging and has Wi-Fi connectivity.

The Analysis Module can accommodate both off-line and online analyses on intercepted packets on the device. To perform various types of analyses, the Analysis Module may extract features from the log files and insert them into a database (an example embodiment being SQLite) on the mobile device.

Alternatively, it may work directly with information on the logfiles maintained by the Log Module. An advantage of doing analysis on the client side is that private information does not need to leak out of the device, setting AntMonitor apart from other systems that perform leakage analysis at the VPN server. In addition, the online analysis capability is important for taking action on live traffic such as preventing private information from leaking. In order to inspect encrypted traffic, the Analysis module may rely on the TLS proxy described above and shown in FIG. 2(b). Data Collection Server: LogServer

The Log Manager can support uploading of files using multipart content-type HTTPS. For each uploaded file, it can check if the file is in proper PCAPNG format. If so, for each client, the manager can store all of its files in a separate folder. In addition, the LogServer can support other logfile formats beyond packet traces (e.g. JSON) used by the Log Module of AntClient.

The Analysis Module on the LogServer can extract features from the log files and insert them into a MySQL database to support various types of analyses. Alternatively, it can use the records extracted and uploaded by the Log and Analysis modules of AntClient. Compared to the Analysis Module of AntClient, the Analysis module on the LogServer may have access to more information, such as the crowdsourced data from a large number of devices, making it suitable for global large-scale analyses. For instance, it could detect global threats and outbreaks of malicious traffic.

Performance Optimization

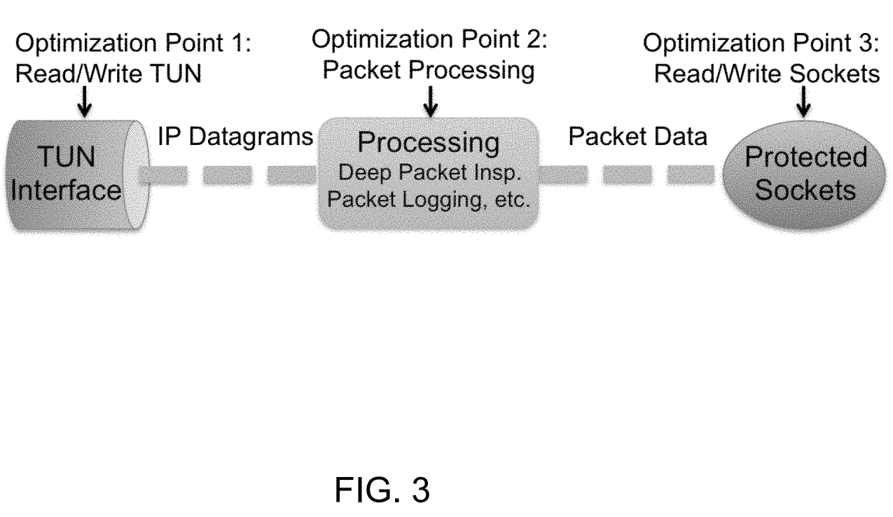

Since AntClient processes raw IP datagrams in the userspace, it may be highly non-trivial to achieve high network performance. We have investigated the performance bottlenecks of our approaches specifically and VPN approaches in general. The bottleneck points are depicted in FIG. 3. We then address the bottleneck points through a combination of optimization techniques, from implementing custom native C libraries to deploying high-performance network IO patterns.

Traffic Routing (Point 1, 2, and 3). The invention can: (i) manage and utilize Direct ByteBuffer for IO operations with the TUN interface and the sockets, (ii) store packet data in byte arrays, and (iii) minimize the number of copy operations and any operations that traverse through the data byte-by-byte. These techniques may be based on the following observations: Direct ByteBuffer may give the best IO performance because it may eliminate copy operation when the actual IO is performed in native code. Plus, Direct ByteBuffer on one platform may be actually backed by an array; therefore, it may create synergy with byte arrays: making a copy of the buffer to a byte array (for manipulation) can be done efficiently by performing memory block copy as opposed to iterating through the buffer byte-by-byte. (Memory copy may be also used whenever a copy of the data is needed, e.g., for IP datagram construction.) Finally, because the allocation of a Direct ByteBuffer may be an expensive operation, the invention can carefully manage its life cycle: for an IO operation, i.e., read from TUN, and reuse the buffer for every operation instead of allocating a new one.

TUN Read/Write (Point 1). A cellular tutorial as well as other systems may employ periodical sleeping time (e.g., 100 ms) between read attempts. This may result in wasted CPU cycles if sleeping time is small or slow read speed if the sleeping time is large, as the data may be available more frequently than the sleep time. To address this issue, we implemented a native C library that performs the native poll( ) operation to read data to a Direct ByteBuffer (which is then available in the code without costing extra copies).

It may be important to be able to read from (and write to) the TUN interface in large blocks to avoid the high overhead of crossing the Code-Native boundary and of the system calls (read( ) and write( ). For instance, in an early implementation of our Mobile-Only approach, we observed that IP datagrams read from the TUN interface have a maximum size of 576 B (which may be the minimal IPv4 datagram size). This may result in the maximum read speed of about 25 Mbps for a TCP connection, thus limiting the upload speed. Increased datagram size may be achieved by (i) increasing the MTU of the TUN interface (to a large value, e.g., 16 KB) and (ii) including an appropriate Maximum Segment Size (MSS, e.g., 16 KB) in the TCP Options field of SYN-ACK datagrams sent by TCP Forwarder when responding to apps' SYN datagrams. These changes may effectively help to ensure that an app can acquire a high MTU (e.g., 16 KB) when performing Path MTU Discovery, so that each read from TUN results in a large IP datagram (e.g., 16 KB). This optimization can result in a maximum read speed of more than 80 Mbps. Similarly, it may also be important to write to TUN in large blocks. For instance, in the Mobile Only approach, it may be possible to construct large IP datagrams (e.g., 16 KB) to write to TUN.

Socket Read/Write (Point 3). Similar to when interacting with the TUN interface, in order to achieve high throughput, it may be important to read from (and write to) TCP sockets in large blocks. In particular, in the Mobile-Only approach, the size of the buffer used for socket read (e.g., 16 KB minus 40 B for TCP and IP headers) can be matched to the size of the buffer used for TUN write (e.g., 16 KB). Similarly, the size of the buffer used for socket write can be matched to that of the buffer used for TUN read.

Thread Allocation (Point 2). NIO can be utilized with non-blocking sockets for the implementation of the Forwarder. In particular, Forwarder can be implemented as a high-performance (proxy) server, that may be capable of serving hundreds of TCP connections (made by the apps) at once, while using only two threads: one thread may be for reading IP datagrams from the TUN and another thread may be for actual network I/O using the NIO Selector and for writing to TUN. Minimizing the number of threads used can be critical on a resource constrained mobile platform to achieve high performance. As a baseline comparison, one application can create one thread per TCP connection, which can rapidly exhaust the system resources even in a benign scenario, such as opening a web page could create about 50 TCP connections, which can result in low performance (see Sec. 4).

Socket Allocation (Point 2). Since the Forwarder may need to create sockets to forward data and one embodiment imposes a limit of 1024 open file descriptors per user process, sockets must be carefully managed. To this end, it may be necessary to minimize the number of sockets used by the Forwarder by (i) multiplexing the use of UDP sockets: using a single UDP socket for all UDP connections, and (ii) carefully managing the life cycle of a TCP socket to reclaim it as soon as the server or the client closes the connection. For comparison, one embodiment uses 1 socket per UDP connection and 2 sockets per TCP connection.

Packet-App Mapping (Point 2). A cellular application may keep active network connections in four separate files in the /proc/net directory: one each for UDP, TCP via IPv4 and IPv6. Because parsing these files can be an expensive IO operation, the reading and parsing of these files can be implemented in a native C library. Furthermore, to minimize the number of times it is needed to read and parse them, it may be necessary to store the mapping of app names to source/destination IPs and port numbers in a Hash Map. When the Log Module receives a new packet, it can first check the Map for the given IP and port number pair. If the mapping does not exist, the Log Module can re-parse the =proc files and update the Map.

Deep Packet Inspection (Point 2). Although inspecting every packet may be costly, the Aho-Corasick algorithm may be written in native C to perform real-time detection without significantly impacting throughput and resource usage. However, using the Aho-Corasick algorithm alone may not be enough. We may also minimize the number of copies we make of each packet. Although the algorithm generally operates on Strings, AntClient can use Direct ByteBuffers for efficient routing and creating a String out of a ByteBuffer object can cost one extra copy. Moreover, some applications use UTF-16 encoding and JNI Strings may be used in Modified UTF-8 format. Any String passed from one application to native C may require another copy while converting from UTF-16 to UTF-8. To avoid two extra copies, the Direct ByteBuffer object may be passed and the Aho-Corasick algorithm may interpret the bytes in memory as characters. This technique may enable us to perform an order of magnitude faster than Java-based approaches.

Performance Evaluation

Tool. In order to evaluate Antmonitor, we built a custom app—AntEvaluator. It transfers files and computes a number of performance metrics, including network throughput, CPU and memory usage, and power consumption. It helps us tightly control the setup and compute metrics that are not available using off-the-shelf tools, such as Speedtest. Scenarios. We use AntEvaluator in two types of experiments. In Sec. 4.1, Stress Test performs downloads and uploads of large files so that AntMonitor has to continuously process packets. In Sec. 4.2, Idle Test considers an idling mobile device so that AntMonitor handles very few packets. In between the two extremes, we have also considered a Typical Day Test, which simulates user interaction with apps; however, it is omitted due to lack of space. Baselines. We report the performance of AntMonitor and compare it to the following state-of-the-art baselines: Raw Device: no VPN service running on the device; this is the ideal performance limit to compare against. State-of-the-art mobile-only approaches: Privacy Guard v1.0 and Haystack [14] v1.0.0.8. (We omit the testing of tPacketCapture since it was shown to have very poor performance in Client-server VPN approaches: industrial grade Strong-Swan VPN client v1.5.0 with server v5.2.1, and an AntMonitor Client-Server implementation based on [17]0.3 The VPN servers used by each app were hosted on the same machine. Setup. All experiments were performed on a Nexus 6, with Android 5.0, a Quad-Core 2.7 Ghz CPU, 3 GB RAM, and 3220 mAh battery. Nexus 6 has a built-in hardware sensor, Maxim MAX17050, that allows us to measure battery consumption accurately. Throughout the experiments, the device was unplugged from power, the screen remained on, and the battery was above 30%. To minimize background traffic, we performed all experiments during late night hours in our lab to avoid interference, we did not sign into Google on the device, and we kept only pre-installed apps and the apps being tested. Unless stated otherwise, the apps being tested had TLS interception disabled and the AntMonitor-App was logging full packets of all applications and inspecting all outgoing packets. VPN servers ran on a Linux machine with 48-Core 800 Mhz CPU, 512 GB RAM, 1 Gbit Internet; the Wi-Fi network was 2.4 Ghz 802.11ac. The files were hosted on a machine within the network of VPN servers. Each test case was repeated 10 times and we report the average.

AntEvaluator may evaluate and compare AntMonitor to existing state-of-the-art approaches. AntEvaluator can transfers files and compute a number of performance metrics, including network throughput, CPU and memory usage, and power consumption. It can help to tightly control the setup, capture, and computation of metrics that are not available using off-the-shelf tools, e.g., Speedtest. AntEvaluator may be used in more than one type of experiments. At one extreme, Stress Test may perform downloads and uploads of large files so that AntMonitor may continuously process packets. At the other extreme, Idle Test can consider an idling mobile device so that AntMonitor may handle very few packets.

Raw Device: no VPN service running on the device; this may be the ideal performance limit to compare against.
State-of-the-art mobile-only approaches: Privacy Guard v1.0 and Haystack v1.0.0.8; both with TLS interception disabled for a fair comparison.
Industrial grade client-server VPN approaches: Strong-Swan VPN client v1.5.0 with server v5.2.1 hosted on the same machine as AntServer.

Unless stated otherwise, for all experiments, AntClient was logging full packets of all applications and inspecting all outgoing packets.

Stress Test

Setup. For this set of experiments, AntEvaluator was used to perform downloads and uploads of files of size 500 MB over a single TCP connection during late night hours in a lab to avoid interference. The files were hosted on a machine within the network of AntServer. In the background, Ant-Evaluator can periodically sample the following metrics:

A. Network Throughput: Instantaneous speed can be computed from the number of bytes transferred every 2 seconds. To allow the TCP connection to reach its top speed, AntEvaluator can discard the statistics in the first 10 sec. At the end of each test, AntEvaluator calculates the standard deviation of the sampled speed. The experiment may be discarded if the deviation is high as it indicates unstable network conditions. For each experiment, AntEvaluator can report the number of bytes transferred after the first 10 sec and the transfer duration, and they may be used to calculate the throughput.
B. Memory Usage: AntEvaluator can use the top command to sample the Resident Set Size (RSS) value.
C. Battery Usage: AntEvaluator can use the APIs available with a hardware power sensor to compute the amount of energy consumption during each test in mAh.
D. CPU Usage: AntEvaluator can use the top command to measure the CPU usage.

At the end of each experiment, AntEvaluator can report the calculated throughput and battery usage, and the average CPU and memory usage. For each VPN app under comparison, experiments were performed and the averages and standard deviations were computed. In the case of CPU usage, the average of the sums of the CPU usage of Ant-Evaluator and the VPN app were reported.

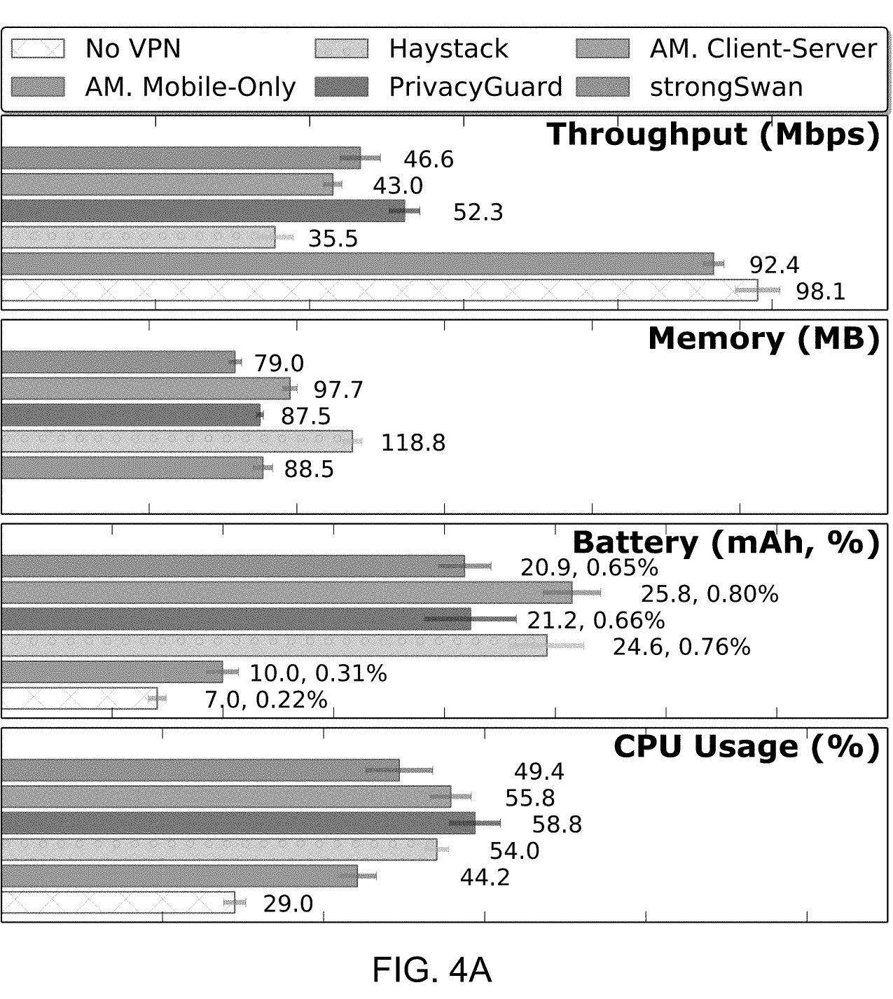

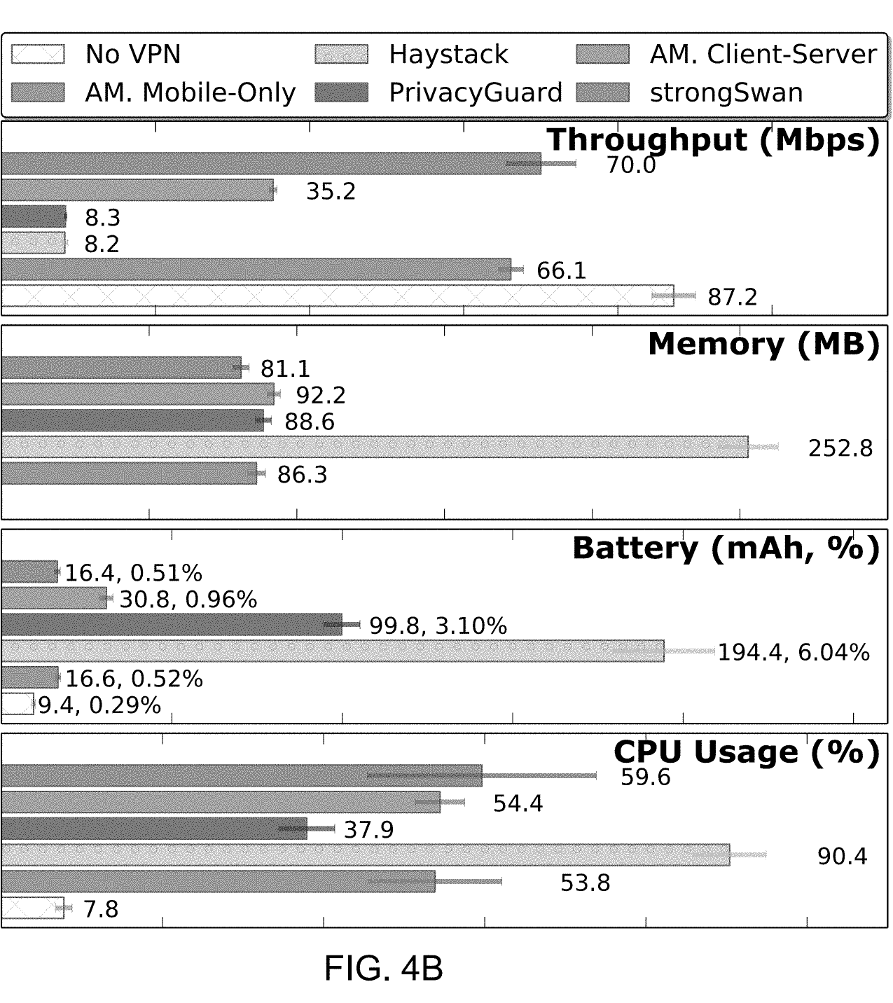

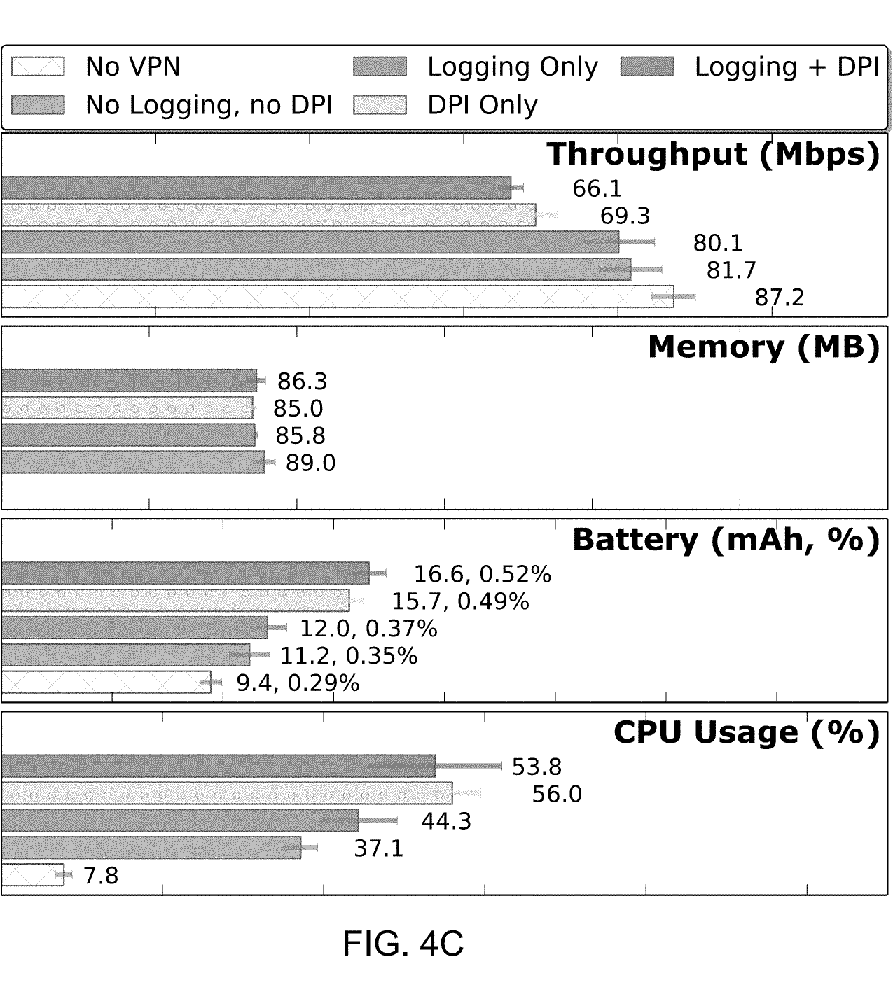

Results. FIG. 4(a) shows that the download throughput of AntMonitor Mobile-Only may outperform all other approaches. In particular, it may be able to achieve about 94% of the raw speed, with good throughput. All VPN apps tested may have similar memory, battery, and CPU usage.

FIG. 4(b) reports the upload performance. AntMonitor-Mobile-Only may achieve 76% of the raw speed while performing data logging and deep packet inspection. Most significantly, its performance may be 8× faster than both state-of-the art Mobile-Only approaches4. FIG. 4(c) shows that AntMonitor Mobile-Only may have higher upload speed (and closest to the raw speed) if DPI is disabled. FIG. 4(b) also shows that all VPN apps may have similar memory and CPU usage.

Summary In general, using any VPN service may roughly double the CPU usage during peak network activity. Although the CPU usage of 38-90% on Wi-Fi seems high, the maximum CPU usage of one platform may be 400%. Finally, this set of experiments may demonstrate that among all VPN approaches, for both downlink and uplink, AntMonitor-Mobile-Only may have the highest throughput while having similar or less usage of CPU, memory, and battery.

Impact of Logging and DPI

Setup. To assess the overhead caused by Logging Data and Deep Packet Inspection (DPI), multiple experiments of upload stress test were performed on AntMonitor Mobile-Only with all four combinations of Logging on/off and DPI on/off.

Results. First, FIG. 4(c) shows that logging may not have a significant impact on throughput. This may be because of (i) the optimization of AntMonitor Mobile-Only that uses only two threads for network IO and (ii) that the data collection uses two threads for storage IO. These data logging threads may not significantly impact main network IO threads on at least one phone. Second, DPI may not be performed by one of the main network IO threads and inflict a 17% slow-down on upload speed. Although 17% may be a significant overhead, AntMonitor Mobile-Only may still able to reach a speed of over 60 Mbps, which may be more than enough for mobile applications. In addition, DPI may cause a 28% and 33% overhead on battery and CPU usage, respectively. However, the CPU usage may still remain ⅛ of the total possible CPU available (of 400%), and thus the overhead may be acceptable. Finally, without logging and DPI, AntMonitor Mobile-Only may achieve 94% of the raw speed without VPN.

Idle Test

Setup. For this set of experiments, the phone was kept idle for 2 minutes with only background apps running. AntEvaluator was used to measure the battery and memory consumption of the VPN app. The aggregate CPU usage was sampled across all apps by summing the System and User % CPU Usage provided by the top command.

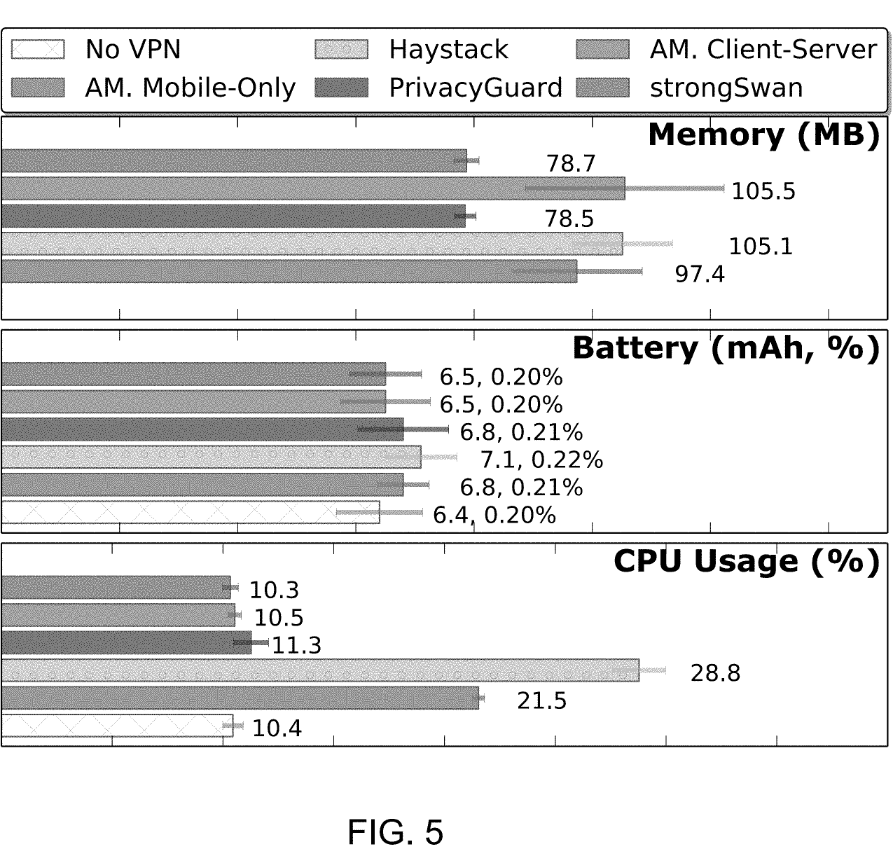

Results. FIG. 5 shows that all apps may create very little additional overhead when the device is in idle mode. Among the mobile-only approaches, Haystack and AntMonitor-Mobile-Only used more CPU than Privacy Guard because both former approaches have threads to log packets while Privacy Guard does not. Logging also results in slightly higher memory usage for Haystack and AntMonitor. Finally, the overall memory usage of VPN apps (˜105 MB) is acceptable; many other popular apps, may use as much as 200 MB RAM.

Metrics Computed Outside AntEvaluator

Latency. We measured the latency of each VPN app by averaging over several pings to a nearby server (in the same city).

String Parsing. The main heavy operation required in DPI may be string parsing. During real traffic conditions, a native C implementation of Aho-Corasick may have a maximum run time of 25 ms. When benchmarking as a standalone library (running on the main thread alone), a parsing time may be <10 ms.

Packet Queue Size. AntMonitor can maintain 2 queues: one for outgoing and one for incoming packets. The outgoing queue can be more heavily loaded as outgoing packets may need to be inspected for privacy leaks.

During a typical stress test of AntMonitor Client-Server, the outgoing queue size may reach a maximum of 17,589 packets. The queue size may be sampled every 5 sec and the outgoing queue size may reach 1,000 approximately 33% of the time, and the incoming queue size may reach 1,000 approximately 4.8% of the time.

Applications

Because AntMonitor can intercept every packet in and out of the device efficiently, it may be uniquely positioned to serve as a platform for supporting applications that build on top of this passive monitoring capability, and which may be of interest to operators as well as individual users. In this section, three applications are considered: (i) privacy leaks detection, (ii) performance monitoring, and (iii) traffic classification. To that end, results are shown from a pilot user study at UC Irvine. The study involved 11 UCI users from our research group, who used AntClient on their phones during the period Feb. 5-Nov. 30, 2015. Ant-Monitor collected the packets of apps that the volunteers selected (FIG. 1(b)) and logged them at Logserver.6

Application I: Privacy Leaks

Mobile devices today may have access to personally identifiable information (PII) and they may routinely leak it through the network, often to third parties without the user's knowledge. PII may include: (i) mobile phone IDs, such as IMEI (which may uniquely identify a device within a mobile network), and a device ID; and (ii) information that can uniquely identify the user (such as phone number, email address, or even credit card) or other information (e.g. location, demographics). The latter type of information may typically not be stored on the phone; however, a user may input and send them to a friend in a previous communication, and the user may want to make sure that no other apps can sniff (e.g. keyboard apps) and send this information elsewhere. Sometimes sending out PII may be necessary for the operation of the phone (e.g. a device must identify itself to connect to a wireless network) or of the apps (e.g. location must be obtained for location-based services). However, the leak may not serve the user (e.g. going to advertisers or analytics companies) or may even be malicious. Leaks in plain text can be intercepted by third parties listening e.g. in public WiFi networks. Although modern mobile platforms require that apps obtain permission before requesting access to certain resources, and isolate apps (execution, memory, storage) from each other, this may not be sufficient to prevent information leaking out of the device, e.g. due to interaction between apps. Users may be unaware of how their data is used.

Privacy Leaks Detection and Prevention Module. AntMonitor functionality may be extended with an analysis module that performs real-time DPI. The user can define strings that correspond to private information that may be prevented from leaking; see screenshot in FIG. 1(c). Before sending out a packet, the AntClient can inspect it and search for any of those strings. By default, if the string is found, AntMonitor can hash it (with a random string of the same length, so as not to alter the payload length) before sending the packet out, and ask the user what to do in the future for the given string/app combination, as shown in FIG. 1(d). The user can choose to allow future packets to be sent out unaltered, block them, or keep hashing the sensitive string (so that the application has a good chance to continue working but without the string being leaked). The system can remember the action to take in the future for the same app and “leak,” and it may no longer bother the user with notifications. The user may also look at the history of the leaks, shown in FIG. 1(e). AntMonitor may be the only tool today that provides both real-time detection and prevention, on the mobile-device (not at the server).

Encrypted Traffic. Since plain text may be required in order to perform DPI, and much of the traffic may be encrypted, a TLS proxy may use a library to intercept secure connections, decrypt the packets, and then re-encrypt them before sending them to their intended Internet hosts. This method may work for most apps, but it may not be able to intercept traffic from highly sensitive apps, such as banking apps, that use certificate pinning. Due to the intrusive nature of intercepting TLS/SSL traffic, we users may disable this option.

Privacy Leaks Detected. A large number of privacy leaks may be in plain text.

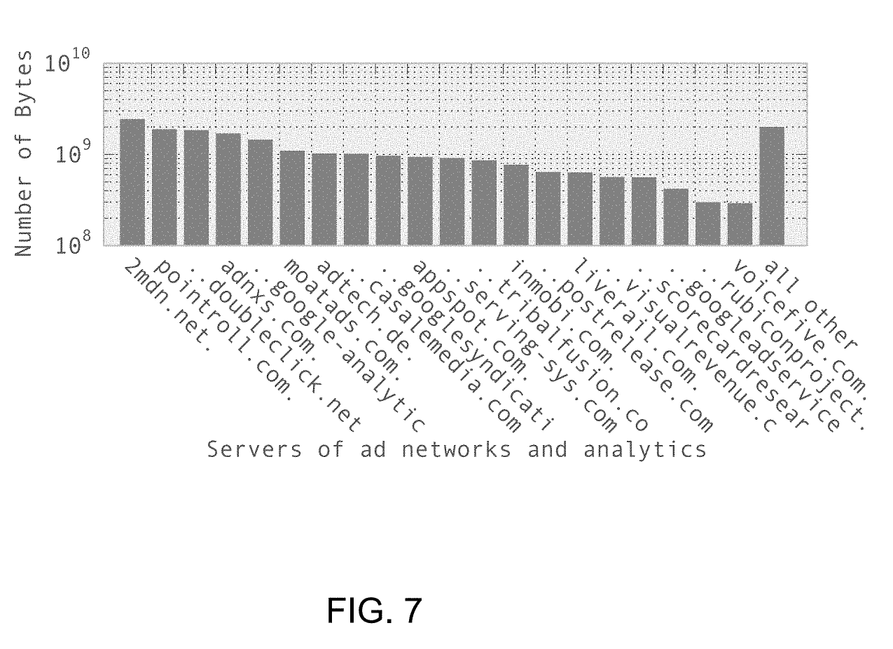

Tracking may be prevalent. Using the data collected by AntMonitor at the users' mobile devices, the amount of data may be calculated that is transmitted from/to ad networks, analytics and mediation services. FIG. 7 shows that the amount of traffic transmitted towards such servers for the top 20 domains may be in the order of GBs, consists of several domains, and tens of thousands of flows per domain. FIG. 1(f) visualizes the destinations for one device: it shows which apps leak information to which destinations. Raising awareness for the magnitude (B) of the tracking is important, and its cost in terms of data plans. AntMonitor can notify individual users about these leaks, real-time.

In summary, the Privacy Leaks module contains the following innovations:

A. Inspection: To inspect packets for privacy leaks we choose to employ an algorithm that allows us to find multiple strings in one reading of the packet, and we choose to do this in native language (e.g. C instead of Java) for the purpose of increasing speed. As an example embodiment, we leverage the Aho-Corasick algorithm written in C, available as an open-source library (http://multifast.sourceforge.net/).

B, Avoiding Extra Copies: Although the algorithm generally operates on Strings, we use Direct ByteBuffers for efficient routing and creating a String out of a ByteBuffer object costs us one extra copy. Moreover, Java Strings use UTF-16 encoding and JNI Strings are in Modified UTF-8 format. This means that any String passed from Java to native C will require another copy while converting from UTF-16 to UTF-8. To avoid two extra copies, we pass the Direct ByteBuffer object and let the Aho-Corasick algorithm interpret the bytes in memory as characters. As an example embodiment, we used a standard Java-based Aho-Corasick implementation (https:/github.com/robert-bor/aho-corasick), a copy from a ByteBuffer to a String would be unavoidable

C. Taking Actions on Privacy Leaks: AntMonitor not only notifies users of privacy leaks, it allows them to choose what to do in the case of a leak. Users can: allow the leak, replace the leaking string with a random one, or block the leak completely. AntMonitor remembers the action to take in the future for the same app and “leak” combination, and it will no longer bother the user with notifications.

Impact of TLS Proxy

In order to be able to inspect encrypted traffic for privacy leaks, we implemented a TLS proxy. To evaluate the performance impact of this proxy, we used AntEvaluator to download a 500 MB file from a secure server over HTTPS and compared the throughput of AntMonitor to that of the Raw Device. The average throughput (in Mbps) was 77.2 and 69.1 for the Raw Device and AntMonitor, respectively. As expected, the proxy introduces an overhead since it uses an extra socket for each connection and performs one extra decryption and encryption operation per packet.

Application II: Performance Measurements

AntMonitor may be used for monitoring network performance (e.g., Wi-Fi and cellular speed, signal strength) and related network information (e.g., type of network, location, time, etc.). This information comes for free to AntMonitor (i.e., without additional CPU or bandwidth overhead) and may be interesting to users (e.g., to manage their network access or cost) as well as to operators (e.g., to assess and improve their infrastructure).

Performance Module. AntMonitor can intercept every packet and thus may be able to passively compute performance indicators of the TCP/IP layer, such as throughput and latency. In addition, it can monitor performance at other layers (e.g., the radio layer) and rich contextual information including but not limited to: (i) timestamp; (ii) geolocation in a way that achieves a low energy footprint; (iii) network information (e.g., WiFi or Cellular), radio access technology (RAT) and detailed cellular network information per region (e.g., LTE parameters, frequency bands); (iv) received signal strength (RSS) or (v) throughput and latency measurements per app and overall. RSS, geolocation, RAT and network connectivity information may be placed in PCAPNG files based on network connectivity/location events posted by the OS. The analysis of the collected data may be done offline at LogServer.

Example Performance Measurements. Regarding signal received power (RSRP) for an LTE network, device throughput may be computed, and results may be computed, for example, for one month (Nov. 7-Dec. 7, 2015), in order to demonstrate the power and versatility of AntMonitor as a passive performance monitoring tool, for individual users as well as network-wide.

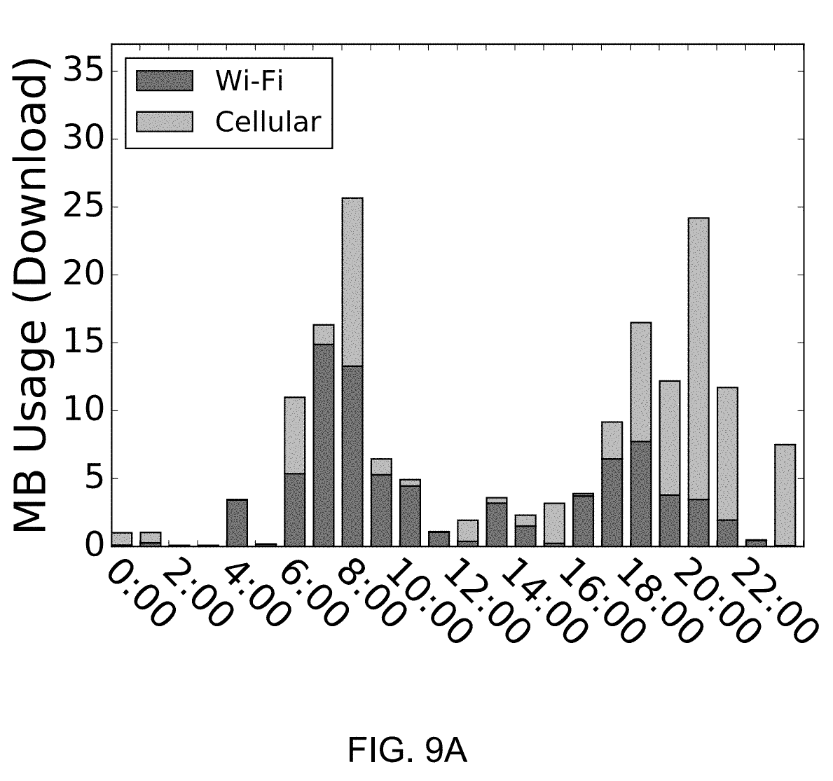

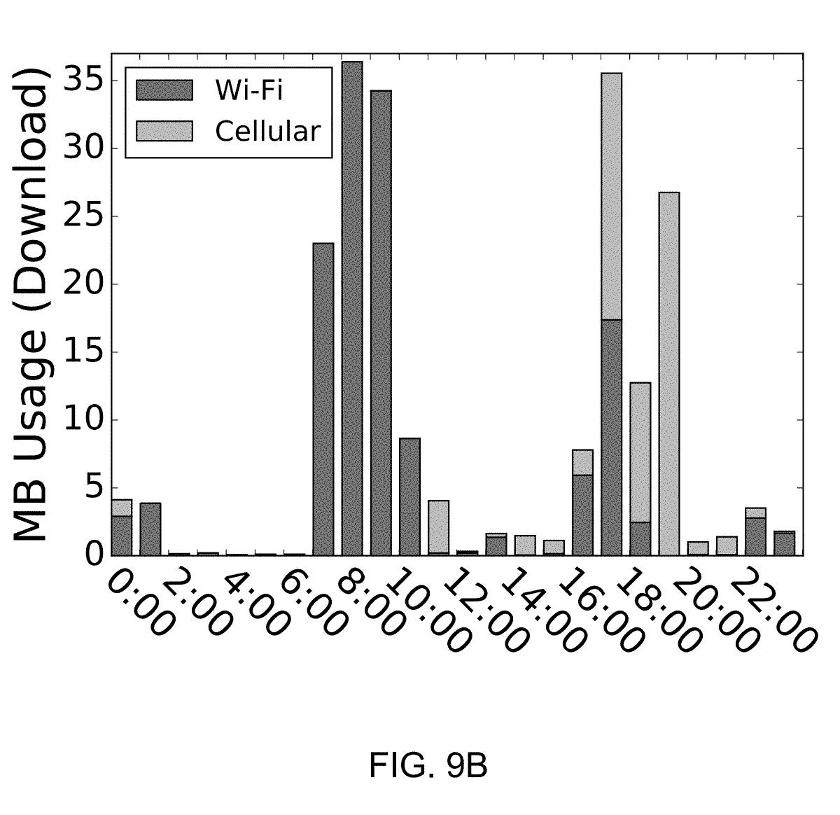

FIG. 9 shows the data (MB) used by a user throughout a “typical” day (i.e., averaged over all week or weekend days). One can see the breakdown of the traffic into WiFi and cellular, the daily pattern and the difference between week and weekend days. This information can be useful to the end-user, by making her aware of usage patterns and giving her more control.

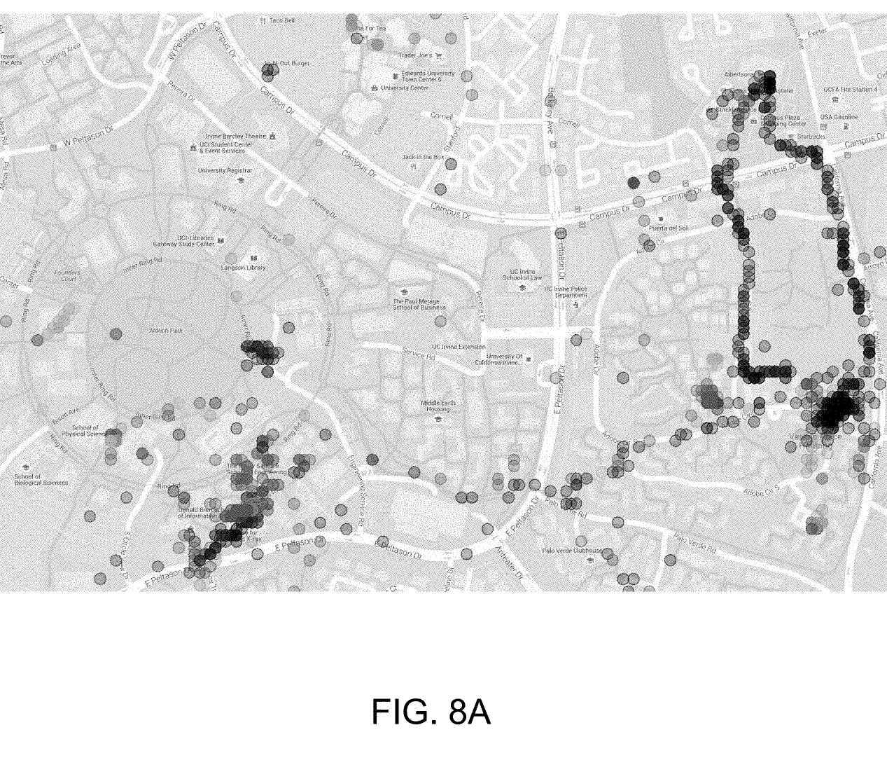

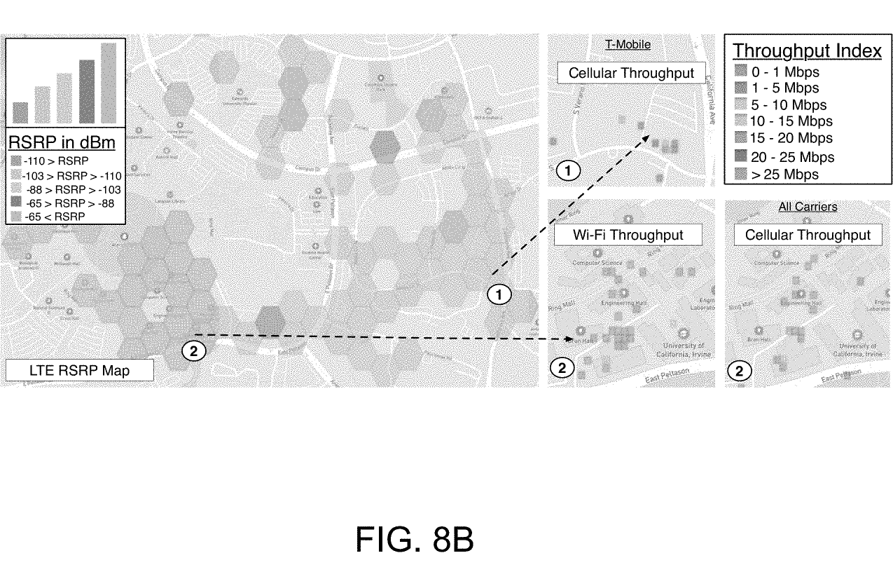

This module of AntMonitor may be used to crowdsource performance measurements and to build performance maps, which can provide a comprehensive view of networkwide performance and can guide control actions. For example, FIG. 8 depicts 5 such performance maps built for the UCI campus, reporting signal strength and QoS parameters per cellular carrier and WiFi. For example, FIG. 8(a) depicts the location of 5 users reported during the one month period (Nov. 7-Dec. 2015) on UCI campus: only with a few users, we are able to cover a large area of the campus. FIG. 8(b) depicts the LTE RSRP for one cellular provider: LTE reception is poor on many areas and has large spatial variation. FIG. 8(b) also reports the throughput of WiFi and cellular networks on campus and compares it to LTE RSRP. This information can, for example, be used to inform decisions about switching among, as well as to better provision these networks. Interestingly, in FIG. 8(b), location 1 has low RSRP but high cellular throughput, thus it is worth to jointly study performance at both layers. With the increasing complexity of cellular networks, many challenges emerged in the deployment, maintenance, and performance characterization of the LTE infrastructure. Ant-Monitor has a unique capability of simultaneously assessing multiple layers of network performance.

Application III: Traffic Classification

AntMonitor can enable learning traffic profiles at different granularities using only features extracted from TCP/IP headers passively monitored. In this section, we demonstrate the capability of (i) flow classification to mobile apps they belong to, and (ii) learning user profiles from the apps they use. These can be useful building blocks for anomaly detection (at the device), traffic differentiation (by the ISP), market research, etc. It may be important to be able to perform these functions using only packet headers, because payload inspection can be costly and invasive; and it may not even be possible as HTTP traffic is moving towards HTTPS. Training and classification can be performed on the device (Log module in the AntClient) and/or at the Log-Server (where data is contributed by multiple devices).

Flow Classification

Packet headers may be collected together with app names that generated the traffic, and may be used to train models and classify flows to mobile apps. Although not the first to classify traffic based on packet headers, AntMonitor may have a unique advantage by design: it can passively collect packets on the device, thus it has access to rich contextual information. For every packet AntMonitor intercepts, it can identify the app it belongs to with 99% accuracy, and append it to the PCAPNG file. This may provide ground truth, which may be hard to get, and which can train accurate classification models. Supervised learning may be used to build a multi-class model that classifies network flows to apps. For each flow, flow features from layer-3 and layer-4 headers may be extracted, on the upstream & downstream directions. The features may be grouped into the following categories: (i) payload and packet size statistics; (ii) burstiness; (iii) packet inter-arrival times; (iv) TCP flags; (v) general, summary statistics of each flow; and (vi) IP features. Different ML models may be compared and selected.

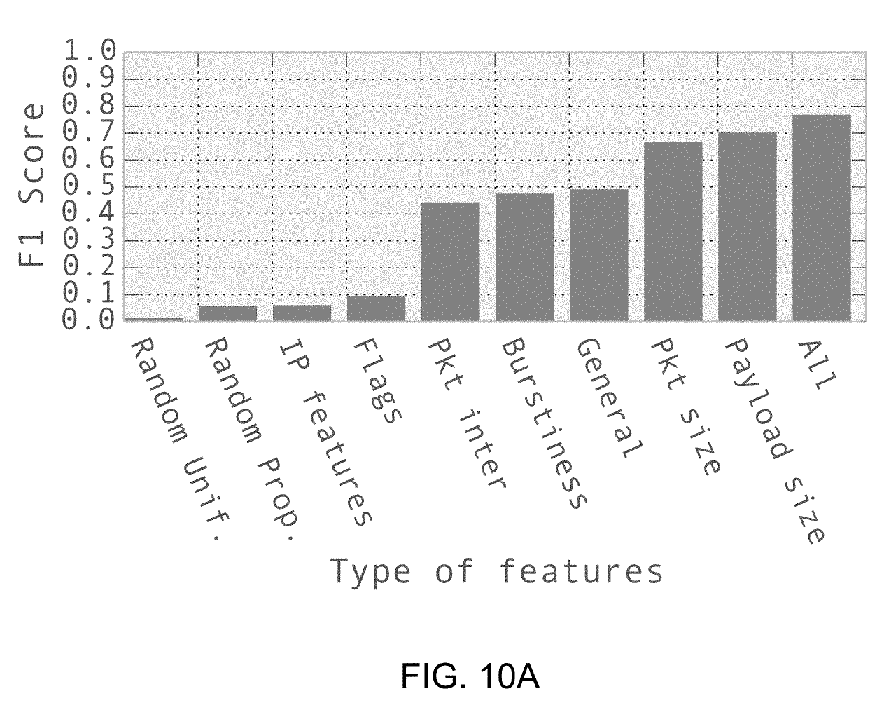

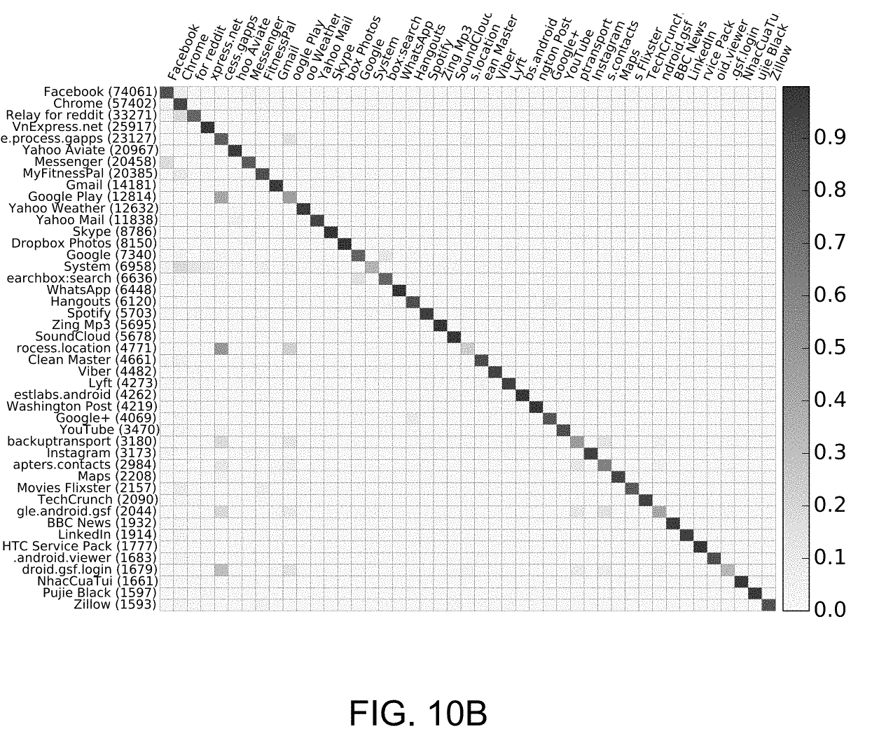

FIG. 10(a) shows the F-1 score for Random Forest performed using an increasing number of features: as a baseline, random uniform and random proportional classification yield F-1 scores of only 1.5% and 5.8% respectively; by combining more feature categories, the performance of the classification may be increased up to an F1-score of 78% when all the features may be used together. Flow classification for an individual user may further increase the classification performance, with the F-1 score ranging between 75%-93%. The latter may be expected, since the number of apps per user may be smaller (ranges between 25-70). FIG. 10(b) zooms in the results for the top 45 apps and shows which apps are correctly classified (diagonal entries), while the few errors (non-zero entries off-diagonal) misclassify similar apps to each other. The fact that by using off-the-shelf learning tools and only features from TCP/IP headers, AntMonitor can classify applications better than state-of-the-art approaches with access to payload, is due to its inherent advantage of having access to accurate ground truth and user behavior at a large scale.

User Profiling

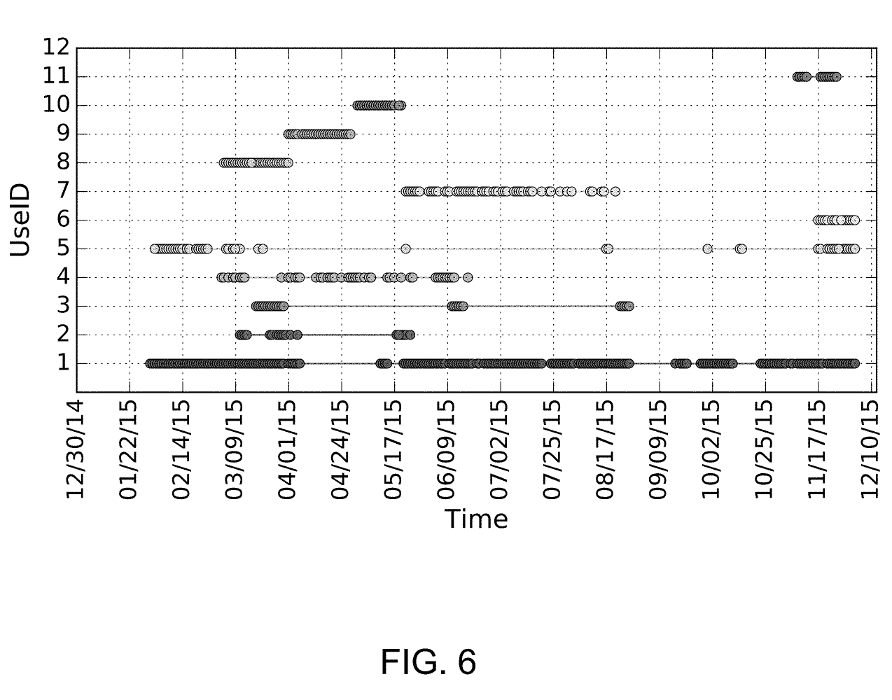

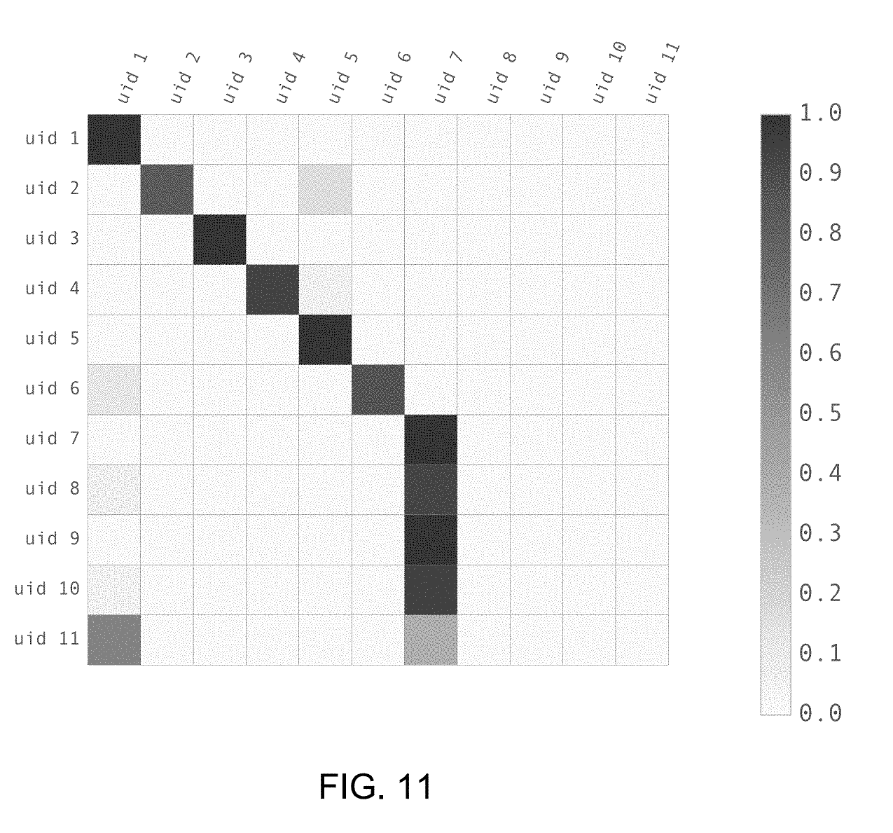

It can be determined whether users in a study group (e.g., see FIG. 6) can be distinguished from each other using their daily app activity. Each user can be modeled with a vector that represents their normalized activity volume over all apps in one day. Certain users may re-install AntMonitor during the study and appear with different user ids. For example, users 7-11 in FIG. 6 are different devices used by the same person over different time periods. Supervised learning can be used in which users 1-7 are included in the training dataset and users 1-11 in testing. FIG. 11 shows the confusion matrix of the learning: users 1-7 are correctly classified to themselves, while users 8-10 are classified mostly as user 7, which is also correct. Interestingly, user 11 is classified as user 1, which also makes sense: during that period the 2 users were working on the same paper deadline and were using their phones for running similar apps for testing and performance evaluation. These results demonstrate AntMonitor's potential for enabling user profiling and anomaly detection.

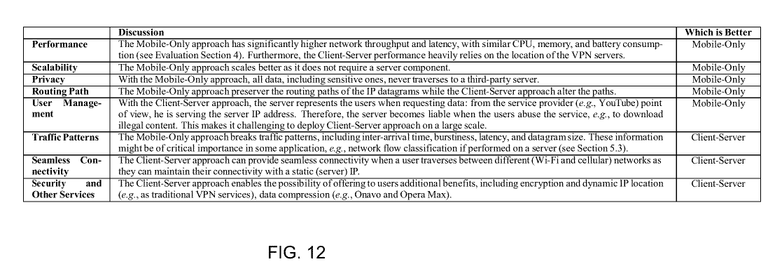

In an embodiment, FIG. 12 illustrates a comparison between Client-Server and Mobile-Only Virtual Private Network approaches.

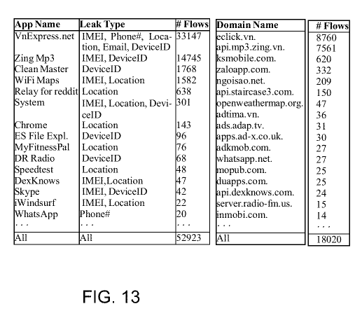

In an embodiment, FIG. 13 presents the apps and destination domains with the highest number of flows leaking. The worst offender in the list was the app VnExpress.net that leaks five different types of PII up to 33,145 times towards the domain eclick.vn—an advertising network. The list of leaking apps includes very popular apps with tens of millions of downloads, such as Skype and WhatsApp, and the list of domains includes many mobile ad networks (such as mopub, inmobi, adkmob, adtima).

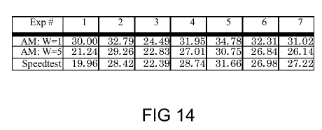

In an embodiment, FIG. 14 illustrates active v. passive throughput measurements. FIG. 14 compares throughput measurements from a state-of-the-art active monitoring tool (Speedtest) vs. passively, (using AntMonitor Client-Server), and we see that the values they compute are very close, but the passive approach does not incur any measurement overhead. For a fair comparison in this table, we passively monitored the Speedtest packets using AntMonitor. In the wild, throughput computations can be made by counting the number of bytes of actual traffic sent over time. Multiple speed tests with 5 minute gaps were ran from the same location, and throughput is mentioned by Speedtest. Also, a maximum average throughput using logs were used over a window of 1 and 5 seconds.

It should be understood, of course, that the foregoing relates to exemplary embodiments of the invention and that modifications may be made without departing from the spirit and scope of the invention as set forth in the following claims.

What is claimed is:

1. A method of mobile network monitoring including:
a graphical user interface that allows a user to turn a virtual private network on or off, select which applications to monitor, select which analysis and logging to perform and what results to upload and visualize;
a method for intercepting all packets in and out of the device that may use a virtual private network (VPN) service on the device;
a routing module that interacts with said intercepting method and routes packets to/from their target/source host;
a log module for logging entire datagrams or metadata on the device, and for uploading all or parts of the log files from the device to a log server; and
an analysis and visualization module on the device and/or at the log server.

2. The method of claim 1, wherein:
a client-server architecture is used to intercept all packets, including a VPN client on the device for intercepting all packets, and a VPN server on the cloud where all packets are routed through; and
the routing module is configured to route a datagram associated with the applications to said VPN server.

3. The method of claim 1, wherein:
a mobile-only architecture of mobile network monitoring is used to intercept all packets; and
the routing module is configured to route a datagram directly to/from the destination/source (without involving a remote VPN server) by having a forwarder module on the device translate all TCP and UDP flows on the device, between raw sockets (using the VPN service) and layer-4 sockets (over the network interface).

4. A method of claim 3 wherein the forwarder module has the following properties:
the forwarder module reads from the raw sockets from the VPN service using an event-based mechanism instead of a sleep-based mechanism; and
the forwarder module uses a mechanism to eliminate string copies by using a shared data structure; and
the forwarder module uses a large Maximum Transfer Unit (MTU) to read/write from/to the raw VPN sockets and reads/writes in large chunks from/to the layer-4 sockets, and matches the sizes between the two; and
the forwarder module minimizes the number of threads used (1 thread for reading, 1 for writing and 1 for connection management) and the number of sockets used (1 socket for all TCP connections and 1 socket for all UDP connections).

5. The method of claim 4, with an additional privacy leaks module, including the following:
an algorithm for searching for multiple strings at the same time;
placing the privacy leaks module in the architecture so as to utilize the shared data structure and minimize memory copies; and
detecting and blocking privacy leaks in real-time.

6. The method of claim 1, with an additional traffic classification and profiling module including:
for traffic profiling, including application classification, anomaly detection and user profiling; while
using accurate ground-truth on a phone, from mapping packets to applications and from other contextual data such as location, time, other running applications in a foreground; and/or
using information uploaded from multiple devices to the log server.

7. The method of claim 1, including a network performance measurement module, including
monitoring of multiple pieces of information on the mobile device at a same time, including WiFi or cellular throughout, RSSP, location and other information that can be read from mobile APIs or inferred from captured packets; and
computing network performance metrics (such as throughput), based on the captured packets, logging them on the device and/or uploading them to the log server, using pcap, pcapng, JSON or other formats.

8. A computer program product for mobile network monitoring, the computer program product comprising a computer readable storage medium having program instructions embodied therewith, the program instructions using a computer processor to cause the mobile device and/or a cloud server to:
allow a user to turn a virtual private network on or off using a graphical user interface and select applications for contributing data to data collection;
manage a network tunnel (TUN) interface and route the data for the data collection by extracting a datagram from the data, routing the datagram to a target host, wrapping a response from the target host in a datagram, and writing the response to the network tunnel interface;
log files with some of the data for the data collection and upload them to a log server; and
analyze packets from the data and visualize them.

9. The computer program product of claim 8, wherein:
a client-server architecture is used to intercept all packets, including a VPN client on the device for intercepting all packets, and a VPN server on the cloud where all packets are routed through; and
a routing module is configured to route a datagram associated with the applications to the VPN server.

10. The computer program product of claim 8, wherein:
a mobile-only architecture of mobile network monitoring is used to intercept all packets; and
a routing module is configured to route a datagram directly to and from the destination and source without involving a remote VPN server by having a forwarder module on the device translate all TCP and UDP flows on the device, between raw sockets (using the VPN service) and layer-4 sockets (over the network interface).

11. A computer program of claim 10 wherein the forwarder module has the following properties:
the forwarder module reads from a TUN interface using an event-based mechanism, instead of a sleep-based mechanism; and
the forwarder module uses a mechanism to eliminate string copies by using a shared data structure; and
the forwarder module uses a large MTU to read/write from/to the TUN interface and reads/writes in large chunks from/to the sockets, and matches the sizes between the TUN interface and sockets; and
the forwarder module minimizes the number of threads used (1 thread for reading, 1 for writing and 1 for connection management) and the number of sockets used (1 socket for all TCP connections and 1 socket for all UDP connections).

12. A computer program of claim 11 wherein the forwarder module has the following properties:
the forwarder module reads from a TUN interface using the poll( ) mechanism available in linux and native C; and
the forwarder module uses the shared BytesBuffer data structure to eliminate string copies between Java and native C parts of the implementation; and
the forwarder module uses a large MTU to read/write from/to the TUN interface and reads/writes in large chunks from/to the sockets, and matches the sizes used at the TUN interface and sockets; and
the forwarder module minimizes the number of threads used (1 thread for reading, 1 for writing and 1 for connection management) and the number of sockets used (1 socket for all TCP connections and 1 socket for all UDP connections)

13. The computer program product of claim 11, with a privacy leaks module, including the following:
an algorithm for searching for multiple strings at the same time; and
placing the privacy leaks module so that it utilizes the shared data structure and minimize memory copies; and
detecting and blocking privacy leaks in real-time.

14. The computer program product of claim 13, with a privacy leaks module, including the following:
the Aho-Corasick algorithm for searching for multiple strings at the same time; and
using BytesBuffer to minimize memory copies.

15. The computer program product of claim 11 with a traffic classification and profiling module, including:
application classification, anomaly detection and user profiling for traffic profiling;
using accurate ground-truth on a phone, from mapping packets to applications and from other contextual data such as location, time, other running applications in a foreground; and
using information uploaded from multiple devices to the log server.

16. The computer program product of claim 11, including a network performance measurement module, including
monitoring of multiple pieces of information on the mobile device simultaneously, including WiFi or cellular throughout, RSSP, location and other information that can be read from mobile APIs or inferred from captured packets; and
computing network performance metrics (such as throughput), based on the captured packets, logging them on the device and/or uploading them to the log server, using pcap, pcapng, JSON or other formats.

17. A computer program product for mobile network monitoring, the computer program product comprising a computer readable storage medium having program instructions embodied therewith, the program instructions using a computer processor to cause the mobile device to:
allow a user to turn a virtual private network on or off using a graphical user interface and select applications for contributing data to data collection;
manage a network tunnel (TUN) interface and route the data for the data collection by extracting a datagram from the data, routing the datagram to a target host, wrapping a response from the target host in a datagram, and writing the response to the network tunnel interface;
intercept the packets on the device using the aforementioned VPN service and corresponding TUN interface;
route a datagram directly to and from the destination and source without involving a remote VPN server by having a forwarder module on the device, by translating all TCP and UDP flows on the device, between raw sockets (using the VPN service) and layer-4 sockets (over the network interface).
the aforementioned forwarder module reads from a TUN interface using an event-based mechanism, uses a shared data structure to eliminate string copies;
the aforementioned forwarder module uses a large MTU to read/write from/to the TUN interface and reads/writes in large chunks from/to the sockets, and matches the sizes between the TUN interface and sockets; and
the forwarder module minimizes the number of threads used (1 thread for reading, 1 for writing and 1 for connection management) and the number of sockets used (1 socket for all TCP connections and 1 socket for all UDP connections).
